(19) United States
(12) Patent Application Publication
(10) Pub. No.: US 2021/0180165 A1
(43) Pub. Date: Jun. 17, 2021

(54) ADDITIVE-CONTAINING ALLOY EMBODIMENTS AND METHODS OF MAKING AND USING THE SAME

(71) Applicant: Oregon State University, Corvallis, OR (US)

(72) Inventors: Somayeh Pasebani, Corvallis, OR (US); S. Milad Ghayoor Baghbani, Corvallis, OR (US); Brian K. Paul, Corvallis, OR (US); Chih-hung Chang, Corvallis, OR (US); Kijoon Lee, Corvallis, OR (US); Yujuan He, Corvallis, OR (US)

(73) Assignee: Oregon State University, Corvallis, OR (US)

(21) Appl. No.: 17/181,955

(22) Filed: Feb. 22, 2021

Related U.S. Application Data
(63) Continuation of application No. PCT/US2019/047944, filed on Aug. 23, 2019.
(60) Provisional application No. 62/722,363, filed on Aug. 24, 2018.

(51) Int. Cl. C22C 38/58; C21D 8/00; C22C 38/34

(52) U.S. Cl. CPC C22C 38/58; B82Y 30/00; C22C 38/34; C21D 8/005

(57) ABSTRACT

Disclosed herein are embodiments of an additive-containing alloy that exhibit improved strength, particularly at high temperatures, creep resistance, thermal fatigue resistance, and oxidation resistance. Also disclosed herein are embodiments of a method for making such additive-containing alloys, including methods whereby the additive component of such alloys can be selectively deposited according to a pre-designed pattern. Such method embodiments facilitate producing programmable alloy embodiments wherein the additive component can be provided in desired regions of the alloy and/or at desired concentrations within the alloy.

### CROSS REFERENCE TO RELATED APPLICATION

This application is a continuation of International Application No. PCT/US2019/047944, filed on Aug. 23, 2019, which in turn claims the benefit of the earlier filing date of U.S. Provisional Patent Application No. 62/722,363, filed on Aug. 24, 2018; each of these prior applications is incorporated herein by reference in its entirety.

### GOVERNMENT SUPPORT

This invention was made with government support under Award Nos. DE-AR0000439 and DE-EE0007888 awarded by United States Department of Energy. The government has certain rights in the invention.

### FIELD

The present disclosure concerns embodiments of an additive-containing alloy and methods of making and using the same.

### SUMMARY

Disclosed herein are embodiments of an alloy comprising a metal matrix phase comprising equiaxed grains of a substantially uniform grain size and wherein the metal matrix phase is substantially free of columnar grains; and an additive phase comprising substantially spherical nanoscale particles and wherein a majority of the substantially spherical nanoscale particles are substantially uniformly distributed within the metal matrix phase and not at external boundaries of the metal matrix phase. In yet additional embodiments, the alloy comprises a first region comprising a first metal matrix phase present in a first matrix concentration and an additive phase present in a first additive concentration, wherein the additive phase comprises substantially spherical nanoscale particles that are substantially uniformly distributed within the metal matrix phase; and a second region having a second metal matrix phase present in a second matrix concentration that is different from the first matrix concentration; wherein each of the first metal matrix phase and the second metal matrix phase independently comprises equiaxed grains and each of the first metal matrix phase and the second metal matrix phase independently are substantially free of columnar grains.

Also disclosed herein are embodiments of a method, comprising adding one or more feedstock powders comprising a metal alloy or a metal alloy mixed with an additive component to a laser powder bed; selectively depositing one or more additive-containing solutions, one or more additive precursor-containing solutions, or a combination thereof in the laser powder bed; cladding a mixture provided by (i) the one or more feedstock powders and (ii) the one or more additive-containing solutions, the one or more additive precursor-containing solutions, or the combination thereof using a laser operated at a power sufficient to sinter or melt the mixture. In some embodiments, the method can further comprise sintering an additive component provided by the one or more additive-containing solutions or the one or more additive precursor-containing solutions after selectively depositing the one or more additive-containing solutions or the one or more additive precursor-containing solutions, wherein sintering comprises heating using a laser operated at a power lower than a power used in cladding the mixture.

### BRIEF DESCRIPTION OF THE DRAWINGS

FIG. 1 is a schematic illustration of a 3-dimensional multifunctional alloy structure comprising regions wherein an additive component has been selectively deposited (represented by the dark grey regions) and regions wherein alloy comprises no additive component (light grey regions).

FIG. 2 is a schematic illustration of a 3-dimensional functionally-gradient alloy product comprising an additive component selectively deposited at increasing concentrations (illustrated by darkening grey regions) within an alloy feedstock powder to provide the product comprising gradient strength.

FIGS. 3A and 3B are high resolution scanning electron microscopy (SEM) images of substantially spherical yttria (wherein yttria is Y₂O₃) nanoparticles embedded in (i) 304 stainless steel wherein the yttria nanoparticles are generated in-situ using a yttria precursor solution and a selective deposition method as disclosed herein (FIG. 3A) and (ii) 304 stainless steel made using a ball-milled feedstock comprising the yttria nanoparticles and the stainless steel alloy followed by exposing the feedstock to a laser sintering process as described herein.

FIG. 4 is a photographic image of nine samples comprising 304 stainless steel without an additive component made using a laser powder bed fusion process.

FIGS. 5A-5C are images showing features of the 304 stainless steel alloy shown in FIG. 4, wherein FIG. 5A is a cross-sectional view of one of the nine samples shown in FIG. 4; FIG. 5B is an optical micrograph showing the microstructure of the sample of FIG. 5A after polishing, wherein the dashed lines show the laser path; and FIG. 5C is an electron micrograph of the sample of FIG. 5A after etching with Fry's reagent.

FIG. 6 is an X-ray diffraction (XRD) spectrum showing XRD patterns of (i) a 304 stainless steel powder comprising 5 wt % yttria powder (bottom spectrum); (ii) a laser powder bed fused product comprising 304 stainless steel 5 wt % yttria (<1 μm) (middle spectrum); and (iii) a laser powder bed fused product comprising 304 stainless steel with no yttria additive (top spectrum).

FIGS. 7A-7C are SEM images of native yttria additive powder (FIG. 7A) and a mixed 304 stainless steel powder comprising 5 wt % yttria powder (FIGS. 7B and 7C).

FIG. 8 is an SEM image showing a representative microstructure of a laser powder bed fused 304 stainless steel comprising 5 wt % yttria after electrochemical etching.

FIG. 9 is a graph showing results obtained from assessing the microhardness of a 304 stainless steel (bottom line) and a laser powder bed fused 304 stainless steel comprising 5 wt % yttria (top line).

FIGS. 10A and 10B are optical microscopy images showing the microstructure of a laser powder bed fused 304 stainless steel (FIG. 10A) and a laser powder bed fused 304 stainless steel comprising 5 wt % yttria (FIG. 10B), wherein it can be seen that the microstructure of the laser powder bed fused 304 stainless steel comprising 5 wt % yttria exhibits equiaxed grains and that the yttria nanoparticles are sufficiently dispersed within the grains and thereby impede dislocation.

FIGS. 11A and 11B are electron backscatter diffraction (EBSD) grain maps obtained from analyzing a sample comprising laser powder bed fused 304 stainless steel (FIG. 11A) and laser powder bed fused 304 stainless steel comprising 5 wt % yttria (FIG. 11 B).

FIG. 12 is a graph of relative density as a function of scan speed, showing the relative density of laser powder bed fused (i) 304 stainless steel (labeled “A”), (ii) 304 stainless steel with 0.5 wt % yttria (labeled “B”); and (iii) 304 stainless steel with 5 wt % yttria (labeled “C”).

FIG. 13 is a graph showing measured microhardness of laser powder bed fused (i) 304 stainless steel (labeled “A”), (ii) 304 stainless steel with 0.5 wt % yttria (labeled “B”); and (iii) 304 stainless steel with 5 wt % yttria (labeled “C”); lines D and E represent an austenitic oxide dispersion strengthened (ODS) alloy made using spark plasma sintering (SPS) and an annealed 304 stainless steel, respectively.

FIGS. 14A and 14B are micrographs of additive-containing alloy samples made using laser powder bed fusion at 400 mm/s; FIG. 14A shows an additive-containing alloy comprising 304 stainless steel and 5 wt % yttria after electroetching and FIG. 14B shows an additive-containing alloy comprising 304L stainless steel and 0.5 wt % yttria after selective laser melting.

FIGS. 15A-15H show a scanning transmission electron microscopy (STEM) micrograph (FIG. 15A) and corresponding energy dispersive X-ray spectroscopy (EDS) maps (FIGS. 15B-15H) obtained from a laser powder bed fused 304 stainless steel comprising 5 wt % yttria.

FIGS. 16 shows tensile test samples used to test for yield strength (YS) and ultimate tensile strength (UTS).

FIG. 17 is a graph showing YS and UTS of a sample comprising annealed 304 stainless steel (labeled as “A”); a sample comprising 304 stainless steel with an yttria additive made using laser powder bed fusion (labeled as “B”); and solution annealed Inconel 625 (labeled as “C”); wherein the samples were tested at room temperature, 600° C., and 800° C.

FIG. 18 is photographic image showing penetration of 10 nm YVO₄:Eu nanoparticles in the a stainless steel powder packed in a 1 cm×1 cm×40 μm holder of fused glass.

FIGS. 19A and 19B are SEM images of yttria printed onto a stainless steel powder bed of representative thickness as used in laser powder bed fusion (LPBF).

FIGS. 20A and 20B are SEM images showing that pores created at the top of the cross-sectional microstructures of certain additive-containing alloy embodiments can be prevented by evaporating solvent from an additive solution prior to laser cladding.

FIG. 21 provides XRD data obtained from analyzing an additive-containing alloy made by selectively depositing an additive precursor on a 304 stainless steel substrate and then performing a laser cladding step.

FIG. 22 shows XRD patterns observed from a sample made using an additive precursor composition comprising an additive precursor in combination with one or more reagents that facilitate conversion to the desired additive component in situ; the (222) peak of the standard cubic phase of the additive component (e.g., yttria) appears at certain laser powers and scanning speeds.

FIG. 23 provides EDS elemental maps showing converted yttria.

FIG. 24 provides EDS elemental mapping images establishing that no carbon layer is observed on the top surface of the sample shown in FIG. 23.

FIG. 25 is an XRD plot obtained after thermal decomposition of a methanol-based additive-containing solution at 600° C. for 1 hour.

FIG. 26 is an SEM cross-sectional image showing that no carbon layer is observed when laser cladding the methanol solvent used in the additive solution of FIG. 25.

FIG. 27 is an XRD plot of a methanol-based precursor solution exposed to different laser energy values achieved by different combinations of laser power and scan speeds (wherein “P” is laser power (W) and “S” is scan speed (mm/s); for example, “P100S150” represents an embodiment where a laser energy of 100 W with a scan speed of 150 m/s is used).

FIG. 28 is a cross-sectional SEM image showing a microstructure of the “P150/S150/ED192” sample of FIG. 27.

FIGS. 29A and 29B show EDS elemental maps (FIG. 29A) and the corresponding spectral analysis (FIG. 29B).

FIG. 30 is an SEM image showing a cross-sectional view of a microstructure of an additive-containing alloy embodiment described herein.

FIGS. 31A and 31B are SEM images of a cross-sectional view of a microstructure comprising embedded yttria in a metal matrix phase (FIG. 31A); FIG. 31B is a close-up view of two different agglomerates observed in the additive-containing alloy.

FIG. 32 is a TEM bright field image of a 304 stainless steel alloy comprising yttria after selective deposition and cladding.

### DETAILED DESCRIPTION

### I. OVERVIEW OF TERMS AND ABBREVIATIONS

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims, are to be understood as being modified by the term “about.” Accordingly, unless otherwise indicated, implicitly or explicitly, the numerical parameters set forth are approximations that can depend on the desired properties sought and/or limits of detection under standard test conditions/methods.

Also, the following description is exemplary in nature and is not intended to limit the scope, applicability, or configuration of the present disclosure. Various changes to the described embodiment may be made in the function and arrangement of the elements described herein without departing from the scope of the preset disclosure. Further, descriptions and disclosures provided in association with one particular embodiment are not limited to that embodiment, and may be applied to any embodiment disclosed. Further, the terms “coupled” and “associated” generally mean fluidly, electrically, and/or physically (e.g., mechanically or chemically) coupled or linked and does not exclude the presence of intermediate elements between the coupled or associated items absent specific contrary language.

Although the operations of exemplary embodiments of the disclosed method and/or system embodiments may be described in a particular, sequential order for convenient presentation, it should be understood that disclosed embodiments can encompass an order of operations other than the particular, sequential order disclosed, unless the context dictates otherwise. For example, operations described sequentially may in some cases be rearranged or performed concurrently. Further, descriptions and disclosures provided in association with one particular embodiment are not limited to that embodiment, and may be applied to any disclosed embodiment.

To facilitate review of the various embodiments of the disclosure, the following explanations of specific terms are provided.

Additive Component: A compound that is capable of improving the strength of an alloy component and that is substantially dispersed within an alloy component when treated with a laser. In some particular embodiments, the additive component is an oxide-containing material. Other additive components, however, are contemplated by the present disclosure unless otherwise indicated.

Additive Precursor: A compound that is capable of being converted to an additive component upon exposure to one or more reagents and/or sufficient energy (e.g., heat). An exemplary additive precursor is Y(NO₃)₃, which can be converted to yttria.

Additive Phase: A phase found in the microstructure of an additive-containing alloy comprising the additive component of the additive-containing alloy.

Cladding: A process wherein a feedstock material (e.g., a powder feedstock) is melted and consolidated using a laser. In some embodiments, cladding can further comprise melting and consolidating a feedstock material and an additive component.

Columnar Grains: Long coarse grains created when a metal solidifies slowly in the presence of a steep temperature gradient. In some instances, relatively few nuclei are available when columnar grains are produced.

Equiaxed Grains: Grains found within the microstructure of additive-containing alloy embodiments disclosed herein that comprise axes of approximately the same length. In some embodiments, equiaxed grains are smaller than columnar grains.

Feedstock, Feedstock Powder, Feedstock Composition: A single powder, or combination of powders that are used as the starting materials used to make the additive-containing alloy embodiments described herein. In some embodiments, these terms refer to the alloy component that provides the majority weight percent of the additive-containing alloy. In some embodiments, the feedstock is used to form a powder layer in a powder bed in which an additive component is selectively deposited. In yet additional embodiments, this term can refer to a feedstock composition wherein an alloy component feedstock is pre-combined with an additive component feedstock and this is used as a feedstock for a method embodiment disclosed herein.

Metal Matrix Phase: A phase found in the microstructure of an additive-containing alloy that comprises the alloy component, which is the component that typically makes up the majority weight percent of the additive-containing alloy.

Microstructure: The fine structure of an additive-containing alloy embodiment, which can constitute, in some embodiments, grains, cells, dendrites, rods, laths, lamellae, precipitates, or the like, that can be visualized and examined with a microscope at a magnification within the range that can be detected using SEM. In some embodiments, microstructure can be visualized at a magnification of 20,000× to 30,000×, such as 20,000× to 25,000×. Microstructure can also include nanostructure; that is, structure that can be visualized and examined with more powerful tools, such as electron microscopy, atomic force microscopy, X-ray computed tomography, etc. In some embodiments, the microstructure of the disclosed additive-containing alloys can consist essentially of the additive component and the alloy component and is free of any contaminants or by-products that deleteriously effect the thermal strength of the additive-containing alloy. In some such embodiments, the microstructure consists essentially of particles of the additive component and equiaxed grains of the alloy component.

Powder Bed: A container or other substrate upon which a feedstock is positioned and wherein laser- or electron beam-facilitated melting takes place. Typically, a powder bed is located on a build plate.

Selectively Depositing, Selective Deposition: A process wherein an additive component (e.g., a strengthening additive, such as an oxide material, a carbide material, a nitride material, a boride material, or any combination thereof) is deposited into selected regions of a powder bed and/or at selected concentrations into the powder bed. In some embodiments, the additive component can be selectively deposited such that it remains in a pre-determined second phase within a laser-melted or laser-sintered material. In yet additional embodiments, the additive component can be selectively deposited at different concentrations such that it provides a gradient of increasingly strengthened alloy (wherein the increased strength corresponds to higher concentrations of the additive component).

Sinter: A high temperature process wherein bonding of particles is induced via solid-state diffusion at a temperature below the melting point of the material being sintered.

Substantially: As used herein with respect to an identified property, shape, location, size, or other circumstance, the term “substantially” refers to a degree of deviation that is sufficiently small so as not to measurably detract from the identified property, shape, location, size, or other circumstance. Any exact degree of deviation allowable may in some cases depend on the specific context.

Voxel-Level Control: A feature wherein selective deposition is controlled in a manner such that the additive component is selectively deposited and/or located in a pre-determined voxel of a product.

Yield strength or yield stress: The stress a material can withstand without permanent deformation, such as the stress at which a material begins to deform plastically.

### II. INTRODUCTION

Technical and cost challenges involved with adding reinforcement nanoparticles to a powder bed have, to date, caused the inability to use additive manufacturing (AM) to produce multi-functional multi-materials in industry. In fact, current powder bed fusion (PBF)-based AM technologies, such as selective laser melting (SLM), are limited to making single-material components and are not capable of making functionally graded materials (FGMs) or metal matrix composites (MMCs) without numerous complicated and costly steps. FGMs are designed for a specific performance or function in which a spatial gradation in microstructure and/or composition lends itself to tailored properties that vary with location in the material. FGMs can be used, for example, in heat sinks, biomedical applications, rocket heat shields, heat engine components, and plasma facings for fusion reactors in a nuclear reactor plant. For example, FGM heat sinks, with selectively distributed and targeted thermal properties, allow for conventional cooling mechanisms (e.g., single-phase liquid or air) to more effectively manage non-uniform heating profiles.

Additive manufacturing is ideally suited to manufacture FGMs and/or MMCs. While methods exist for making FGMs, these methods have drawbacks. For example, a directed energy deposition (DED) method, in which powder is blown into a melt pool under a moving laser, has been employed for manufacturing functionally graded 304 stainless steel and Inconel 625 alloy by varying the powder composition between the layers of Inconel 625 on 304 stainless steel; however, DED has several limitations that have not been addressed, such as formation of undesirable intermetallic phases and low dimensional accuracy. Also, ball-milling has not been shown in the art to successfully create a graded composition within the powder to manufacture FGMs. Furthermore, ball-milling methods are time consuming and expensive. Also, ball-milling does not disperse the particles uniformly in short time periods that would be needed on an industrial scale and it changes the morphology of the powder and reduces flow, packing and wetting properties, which leads to higher porosity and cracking in the final products.

Disclosed herein are additive-containing alloy embodiments and methods for making such additive-containing alloys that address drawbacks associated with current oxide dispersion strengthened (ODS) methods and alloys. The disclosed method and alloy embodiments provide unique alternatives to conventional alloy manufacturing methods and/or alloys because, for example, method embodiments of the present disclosure can be used to synthesize the additive-containing alloy directly while concurrently making a final product (e.g., a structural component or other product) comprising the additive-containing alloy. In other words, the method avoids having to prepare an alloy stock material (e.g., ingot, bars, etc.) using conventional steps (e.g., ball-milling precursor powders, vacuuming, degassing, hot extrusion, etc.) and then, in separate steps, machining or forming the alloy into a final product with machining steps (e.g., shaping/molding, welding, and/or otherwise manipulating the alloy) to provide the final product. Such conventional product forming steps create wasted alloy materials and also are physically demanding/difficult to do on large scale. Method embodiments disclosed herein also are programmable in the sense that a particular alloy composition can be pre-designed and then programmed into a computer, which can then dictate selective deposition (e.g., by using a printer) of the additive component. This facilitates an incredible level of control and manipulation of alloy composition and development that cannot be obtained using conventional ball-milling.

Additive-containing alloy embodiments disclosed herein also have reduced alloy impurity content and possess microstructural features that are not obtained using conventional ball-milling. Also, the additive-containing alloy and method embodiments of the present disclosure can be used to provide products that have a plurality of structural features and/or regions having a different alloy make-up, such that the strength and/or temperature tolerance of a particular region and/or structural feature can be tuned by including additive components disclosed herein, whereas other regions that do not require such increases can be provided without the additive. Such components can be made in a single manufacturing process with programmable dispersion strategies disclosed herein.

### III. METHOD EMBODIMENTS

Disclosed herein are embodiments of a method for making an additive-containing alloy. The method embodiments provide the ability to obtain additive-containing alloys that can be used to form various structural components wherein the additive-containing alloy makes up the material of the structural component, or a portion thereof. In some embodiments, such structural components can be formed directly. For example, some method embodiments can be used to provide a structural component that comprises a homogenous mixture of the alloy and additive components of the additive-containing alloy. Also, some method embodiments can be used to provide a structural component with regions that comprise different concentrations of the additive component such that the additive component can be positioned/located in certain regions and not in others and/or can be provided at certain concentration levels in certain regions and at different concentration levels in other regions. For example, in some embodiments, an additive component can selectively be deposited into an alloy component (e.g., a feedstock powder) prior to further treating the alloy component (e.g., prior to laser cladding), which provides a revolutionary method for making products comprising an additive component present in the base alloy directly. Such method embodiments do not require conventional ball-milling or hot extrusion steps and thus provide the ability to produce components in a significantly reduced time period, as well as at reduced cost.

In some embodiments, the method comprises layering one or more alloy feedstock powders in a powder bed, selectively adding an additive component (or a precursor thereof) to the powder bed, obtaining an additive component-containing mixture, and consolidating the additive component-containing mixture, such as by cladding (e.g., laser powder bed fusion/cladding). These steps can be performed in this particular order, or in a different order. And, any of these steps can be repeated for a number of times until the final product is made. For example, in some embodiments, the method can comprise selectively adding the additive component (or the precursor thereof) to a surface of the powder bed (without any feedstock powders present) and then layering one or more alloy feedstock powders on the deposited additive component and then consolidating the resulting additive-containing mixture. Embodiments where the method is conducted in this order can be useful in facilitating solvent removal from the solution comprising the additive component (or the precursor thereof). In yet additional embodiments, the additive component can be added into an alloy feedstock powder which is first placed in the powder bed. In additional embodiments, one or more additional steps, such as sintering, can be used in the method. For example, in embodiments where the additive component (or precursor thereof) is deposited first, the method can further comprise sintering the additive component (or precursor thereof) at a low power that is not so hot as to melt the additive component (or precursor thereof). In some embodiments, this additional sintering step can be used to prevent undesirable features in the resulting alloy product, such as scale (e.g., agglomerated oxide components). In yet additional embodiments, the method can comprise performing a plurality of selective deposition steps to provide a plurality of different additive component regions and/or a plurality of different additive component concentrations in the resulting product. In such method embodiments, each deposition step can comprise adding the same additive component (or precursor thereof); or each deposition step can comprise adding a different additive component (or precursor thereof) that the one before it; and/or each deposition step can comprise adding the same additive component (or precursor), but at a different concentration than the one before it.

In some embodiments, the additive component, which can be as described herein, can be provided as a solution such that an additive component powder is dissolved or dispersed in a suitable solvent (e.g., an alcohol, such as methanol, ethanol, propanol, butanol, or the like; water; a glycol, such as ethylene glycol; or a combination thereof). In some other embodiments, a precursor to the additive component can be provided (also referred to herein as an additive precursor), along with one or more reagents that facilitate forming the additive component from the precursor in situ. In such embodiments, the precursor and the one or more reagents can be provided as a solution using a suitable solvent (e.g., an alcohol, such as methanol, ethanol, propanol, butanol, or the like; water; a glycol, such as ethylene glycol; or a combination thereof). In some embodiments, the additive precursor can be a metal nitrate (e.g., Y(NO₃)₃), or a metal hydroxide (e.g., Y(OH)₃) that can be oxidized to a corresponding metal oxide. In some embodiments, the additive precursor can be dispersed in an acidic solution. The one or more reagents can comprise chemical compounds capable of reacting with the additive precursor to provide the corresponding additive component. In some embodiments, the one or more reagents can be selected from citric acid, glycine, hydrazinium carbazate, urea, or the like. Exemplary reaction pathways by which these reagents can be used to form yttria, an exemplary additive component, from Y(NO₃)₃ are summarized below in Equations 1, 2, and 3. In some embodiments, the cladding step of the method can provide sufficient energy to promote the conversion of the precursor to the additive component.

6Y(NO₃)₃+5CH₂COOHCOHCOOHCH₂COOH→3Y₂O₃+30CO₂+20H₂O+9N₂ (Equation 1)

6Y(NO₃)₃+10NH₂CH₂COOH→3Y₂O₃+20CO₂+25H₂O+14N₂ (Equation 2)

2Y(NO₃)₃+5NH₂CONH₂→Y₂O₃+5CO₂+10H₂O+8N₂ (Equation 3)

In some embodiments utilizing an additive precursor and the one or more reagents, the method can further comprise removing gas by-products by flowing an inert gas, such as nitrogen, over the powder bed. In some exemplary embodiments, urea can be used as a reagent in combination with Y(NO₃)₃ to provide yttria with low release of water and CO₂, thereby avoiding these potential contaminants in the product during any laser cladding step. Additionally, embodiments using additive precursors can involve using higher initial concentrations of the additive precursor in the solution that is selectively added and thereby can decrease the amount of solvent needed for the deposition step and thus decrease time and cost parameters of the method.

In some embodiments, after evaporation of the solvent used in any additive-containing and/or additive precursor-containing solutions, the powder bed remains as a solid layer of powder with the added additive component until cladding with a laser is conducted to facilitate melting. Representative cladding parameters are disclosed herein. In some embodiments, cladding can comprise using a laser operated at a power ranging from 90 W to 160 W, such as 100 W to 150W. Without being limited to a single theory, it currently is believed that for cladding steps of the present disclosure, additive component (often in the form of particles) is convected from the surface toward the center of a melt pool once formed. In some embodiments, the melt pool is the shallowest region with a constant surface tension/constant temperature. The strong temperature gradients below the laser creates a temperature-dependent surface tension in the melt pool, which can cause a Marangoni effect that is driven by temperature-dependent surface tension. In some embodiments, this can drive the melt flow from the hot laser spot toward the cold rear, which helps to increase the melt depth and recirculate the melt flow which can effectively facilitate dispersing the additive component homogenously inside the melt pool and eventually inside the metal matrix phase upon solidification.

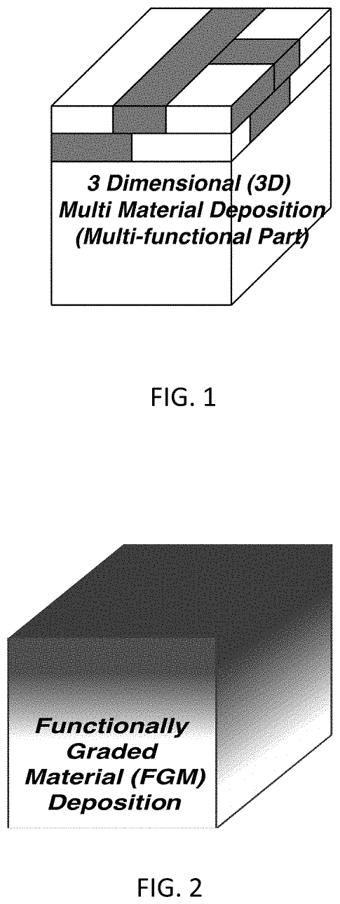

Method embodiments disclosed herein can be programmable in the sense that the chemical make-up of a final product can be pre-designed, such as by using a computer program, and that specific design can be made in the product using a method embodiment wherein feedstock powder layering, additive component selective deposition, and/or cladding steps are carried out in a manner that provides the specific design. In some embodiments of a programmable method, the additive component of the additive-containing alloy is selectively added according to a particular design by pre-programming an alloying device with a computer-generated design. In some embodiments, selectively adding the additive component (or a precursor thereof) can comprise depositing the additive component using an alloying device to selectively deposit the additive component (or a precursor thereof) at a pre-selected region in the powder bed. For example, the additive component can be provided as a solution comprising a solvent and the additive component and the solution can be jetted using a printer (e.g., a digital ink-jet printer), sprayed using a spray-head apparatus, or otherwise deposited in a pre-selected region of the powder bed. In other embodiments, an additive precursor and one or more reagents, such as those discussed above, can be provided as a solution and then the solution can be jetted, sprayed, or otherwise deposited in a pre-selected region of the powder bed. Upon laser cladding, the additive precursor can be converted to the desired additive component (e.g., through decomposition and/or combustion). Such method embodiments can be used to make products wherein the additive component is homogenously distributed throughout the alloy component of the product and/or products wherein the additive component is distributed in certain regions of the alloy component such that a binary structure can be achieved (e.g., a MMC). A schematic illustration of an additive-containing alloy binary structure is provided in FIG. 1, wherein regions (e.g., voxels) of the product comprise the alloy with no additive component (light grey regions) and other regions (e.g., voxels) of the product comprise the alloy with an additive component (dark grey regions). Method embodiments disclosed herein are able to provide voxel-level control wherein deposition is controlled in a manner such that the additive component is selectively deposited and/or located in a pre-determined voxel of a product.

In yet additional embodiments, different concentrations of the additive component, or the precursor thereof, can be selectively deposited using the programmable method, such as to provide voxel-level control. For example, a printer that is pre-programmed with a particular design or pattern can be used to deposit a solution comprising a first concentration of the additive component (or a precursor thereof) in a first pre-selected region and then the printer can deposit a solution comprising a second concentration of the additive component (or a precursor thereof) in a second pre-selected region. Such selective deposition methods can be used to provide, for example, FGMs. A schematic illustration of a functionally graded additive-containing alloy embodiment is provided in FIG. 2, wherein different concentrations (e.g., gradually increasing concentrations) of the additive component can be embedded in the alloy component.

In some embodiments of the method, the additive component can be provided as a solution comprising greater than 0 wt % to 15 wt % of the additive component, such as 0.0001 wt % to 14 wt % or 0.001 wt % to 13 wt % of the additive component, or 0.01 wt % to 12.6 wt % of the additive component. In some embodiments of the method, a precursor of the additive component can be provided as a solution comprising greater than 0 wt % to 40 wt % of the precursor, such as 1 wt % to 38 wt %, or 1 wt % to 37 wt %, or 5 wt % to 25 wt %, or 5 wt % to 23 wt %, or 5 wt % to 22.5 wt % of the precursor.

In some embodiments of the method, the laser power used for cladding can range from 90 W to 200 W, such as 100 W to 175 W, or 100 W to 150 W. Any suitable number of laser scans can be used per cladding step, such as 1 scan to 1000 scans, or 1 scan to 500 scans, or 1 scan to 200 scans, or the like; and, in some embodiments, a single laser scan can be used per each cladding step.

In yet additional embodiments, the method comprises mixing the additive component with an alloy, such as by ball-milling, and then performing a cladding step using a laser powder bed fusion process. In such embodiments, the ball-milled additive-containing powder precursor(s) is not melted, but instead is sintered at lower laser powers. By avoiding any melting of the additive-containing powder precursors and instead using a laser powder bed fusion process, such as in this particular method embodiment or any of the programmable method embodiments discussed above, it is possible to obtain products that have microstructural features that facilitate desirable thermal stability and strength. As discussed herein, in some embodiments, the microstructures of any such additive-containing alloys can comprise a metal matrix phase comprising equiaxed grains having a substantially uniform grain size and an additive component phase comprising substantially spherical nanoparticles of the additive component. These substantially spherical nanoparticles are uniformly distributed with the metal matrix phase. This uniform distribution of spherical nanoparticles is not obtained using conventional ball-milling and melting methods, but instead can be provided by selectively depositing the additive component before or after adding an alloy feedstock powder and then using a cladding step to facilitate in situ production and/or dispersion of the additive component.

In an independent embodiment, method embodiments disclosed herein do not comprise using a titanium-containing compound as an additive component or an additive precursor. In yet other independent embodiments, method embodiments disclosed herein do not comprise using milling techniques (e.g., ball-milling) to disperse the additive component (or a precursor thereof) into a metal matrix phase of an alloy.

Method embodiments described herein can be used to make additive-containing alloys for use in a variety of structural components for myriad applications. For example, additive-containing alloys made using method embodiments described herein can be used in high temperature, high pressure gas/gas or liquid/liquid heat exchangers using cheaper feedstock alloy powders, particularly as compared to such products made using nickel-based superalloys and made by conventional ball-milling methods. Method embodiments described herein can be used to impart voxel-level control to products described herein.

Hybrid compact heat exchangers are being considered as secondary heat exchangers for supercritical carbon dioxide (sCO₂) power plants involving the use of molten sodium salts. In such heat exchangers, the molten salt would take the larger set of channels (to improve pressure drop), and the sCO₂ would take the smaller set of channels (to handle differential pressure between streams). As such, the thin regions between the sCO₂ channels may need more strength than those in other regions of the heat exchanger and thus should be made with a stiff, corrosion-resistant material capable of being operated at high temperatures. While high chromium content, iron-based ferritic oxide dispersion strengthened (ODS) steels could be used for such devices, these materials are not readily available commercially or widely utilized because of their high production costs and other issues. And, the current way of manufacturing ODS steels is to first force a highly stable rare earth (RE) element into an Fe-based matrix by severe plastic deformation and bond breaking via high energy ball-milling and then re-forming complex oxide compounds during subsequent hot consolidation and extrusion. This method, however, presents manufacturing limitations and cost requirements, such as those discussed herein. Furthermore, fabrication of a consolidated alloy into a mechanical component, such as a heat exchanger, has been found to be technologically challenging. In contrast, using the programmable method embodiments disclosed herein, the regions between sCO₂ channels can be designed to comprise an additive component that is selectively deposited using a programmable method embodiment disclosed herein. The remainder of the structure comprising the sCO₂ channels can comprise an alloy that does not require the additive for temperature stability by designing the programmable method to avoid depositing the additive component in this region.

In some embodiments, the additive-containing alloy embodiments and method embodiments disclosed herein can be used to make high temperature recuperators. Such recuperators typically are made with Ni-based superalloys that are several times more expensive than stainless steel alloys. Stainless steel typically is not used in such structures because 300 series stainless steel alloys exhibit creep issues at temperatures above 550° C. The presently disclosed additive-containing alloy embodiments can be used to replace Ni-based superalloys in high temperature recuperators, such as those that have a thermal gradient from one side to the other from around 750° C. to below 550° C. Method embodiments disclosed herein can be used to make a binary product wherein the additive component is programmed to be deposited such that its concentration in the alloy component increases gradually to thereby provide a recuperator that comprises a low temperature side (made-up of the alloy component, such as 304 stainless steel) and a high temperature side (provided by the regions of the product comprising higher concentrations of the additive component).

In yet additional embodiments, the programmable method embodiments disclosed herein can be used to make additive-containing alloys that can replace conventional alloys used for other types of products. For example, MA957 (Fe—14Cr—1Ti—0.25Mo—0.25Y₂O₃) and 14YWT (Fe—14Cr—0.4Ti—3W—0.25Y₂O₃) have been used in Gen-IV fission reactors due to their high radiation resistance and high creep strength at elevated temperatures. However, these alloys are made using mechanical alloying of pre-alloyed or elemental powder mixture and subsequent powder consolidation via hot extrusion or hot isostatic pressing, which are very costly, time consuming, and yield inconsistent results. Also, it is not practical to weld such alloys via conventional welding and fusion welding techniques. In contrast, the method embodiments disclosed herein can be used to make additive-containing alloys that comprise microstructures as described herein. As such, these additive-containing alloys are not prone to solidification cracking, surface roughness, or contamination issues that the MA957 and 14YWT alloys exhibit. Also, the method embodiments disclosed herein can provide additive-containing alloys with these superior properties and that can be made directly into 3D net-shaped parts without having to weld separate components together and/or without having to use melting to build full-density parts.

In some independent embodiments, the method can be used to fabricate, in situ, a porous component with a catalyst. In such embodiments, laser sintering of a loose powder bed can be used to make a porous structure and then the porous surface can be functionalized with a catalyst support film using a reactive precursor, and then a catalyst can be printed and sintered on top of the catalyst support film. In some embodiments, a low-powered laser can be used to expand the particles in the bed to loosen up the bed thereby facilitating porosity. Then sintering at a slightly higher power can be used to create a porous structure with open pores. A chemical precursor can then be deposited into the porous bed to functionalize the surface of the porous carrier with a catalyst support film. Another treatment using the low-powered laser can facilitate activating the film and then a colloidal suspension of the catalyst can be deposited. One or more optional sintering steps can then be used.

### IV. ALLOY EMBODIMENTS

Disclosed herein are embodiments of an additive-containing alloy comprising one or more alloy components comprising alloying elements; and an additive component. The one or more alloy components can be a combination of elements suitable to provide an iron-based alloy, a nickel-based alloy, an aluminum-based alloy, or any other such alloys. In some embodiments, the alloy component can comprise a combination of elements suitable to provide an iron-based alloy, such as a stainless steel material. In some embodiments, the alloy elements can be selected from carbon, chromium, manganese, silicon, phosphorus, sulfur, nickel, nitrogen, iron, and the like. In some particular embodiments, the alloy component can comprise stainless steel 304 (Fe—18Cr—8Ni—2Mn—1Si), stainless steel 304L, or a combination thereof. The additive component can be a material comprising an oxide material, a carbide material, a nitride material, a boride material, or any combination thereof. In some embodiments, the additive component comprises, or is converted in situ to a metal oxide, such as yittrium oxide (also referred to herein as “yttria”), aluminum oxide, lanthanum oxide, other rare earth oxides, or combinations thereof. In an independent embodiment, if the additive component is aluminum oxide, then the aluminum oxide is not used in combination with a Ti6Al4V alloy.

In some embodiments, the additive component is dispersed in a matrix of the one or more alloys. In such embodiments, the alloy component comprises, or provides, a metal matrix phase and the additive component is dispersed therein to provide an additive phase within the metal matrix phase. In some embodiments, the additive-containing alloy comprises a metal matrix comprising equiaxed grains of a substantially uniform grain size and an additive phase. In some such embodiments, the additive phase can comprise substantially spherical nanoscale particles that are substantially uniformly distributed within the metal matrix phase. In embodiments where the substantially spherical nanoscale particles are substantially uniformly distributed, a majority of the substantially spherical nanoscale particles do not agglomerate at edges of the equiaxed grains of the metal matrix. In some embodiments, the equiaxed grains can have an average grain size ranging from 1 micron to 18 microns, such as 1 micron to 10 microns, and in some embodiments, the equiaxed grains can have an average grain size ranging from 1 microns to 5 microns, such as 2 microns to 4.5 microns, or 2 microns to 4 microns, or 2 microns to 3 microns. In independent embodiments, the equiaxed grains have an average grain size less than 7 microns. In particular embodiments, the metal matrix phase is substantially free of columnar grain structures. For example, in some embodiments, it currently is believed that the additive component can facilitate heterogeneous nucleation by acting as an inoculant.

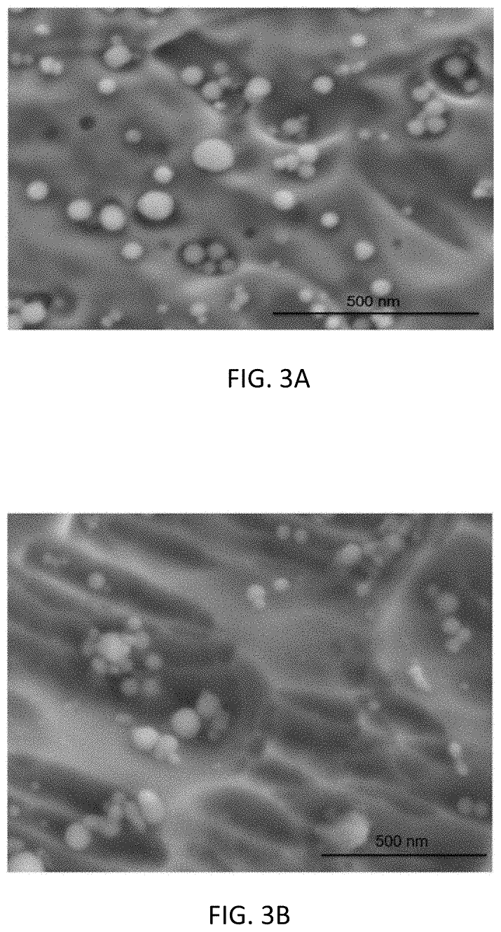

In particular disclosed embodiments, the substantially spherical nanoscale particles comprise an oxide-containing material, a carbide material, a nitride material, a boride material, or any combination thereof. In particular embodiments, the substantially spherical nanoscale particles comprise yttria or alumina. In some embodiments, a portion of the substantially spherical nanoscale particles of the additive phase are disposed in micron-scale particles within the metal matrix phase. In particular embodiments, the substantially spherical nanoscale particles have an average size ranging from greater than 0 nm to 200 nm or less, such as 0.1 nm to 150 nm, 0.1 nm to 100 nm, or 0.1 nm to 80 nm, or 0.1 nm to 60 nm, or the like. In some embodiments, the average size of the substantially spherical nanoscale particles ranges from 10 nm to 150 nm, such as 10 nm to 100 nm, or 10 nm to 80 nm. In an independent embodiment, the metal matrix phase does not comprise substantially spherical nanoscale particles that have a size of 190 nm or greater (e.g., 200 nm to 1 μm). The substantially spherical particles can promote improvements in powder layering in the method embodiments disclosed herein as tap densities can contribute to final densities of components made using such methods. As such, the substantially spherical particles can promote superior densities in additive-containing alloys described herein. Exemplary images showing microstructures of representative alloy embodiments comprising substantially spherical nanoscale particles of an additive component, wherein the nanoscale particles are substantially uniformly distributed within the metal matrix phase, are provided by FIGS. 3A and 3B.

The additive phase may be present in an amount ranging from 0.01 wt % to 2 wt %, such as 0.01 wt % to 1.5 wt %, or 0.01 wt % to 1 wt %, or 0.01 wt % to 0.5 wt % and the metal matrix phase makes up a balance of the alloy. As disclosed herein the metal matrix phase can be provided by a steel-based alloy, such as a stainless steel alloy. In particular embodiments, the metal matrix phase is provided by a grade 304 stainless steel. In some embodiments, the substantially spherical nanoscale particles of the additive phase comprise yttria.

Also disclosed herein are embodiments of an additive-containing alloy wherein the additive component is selectively deposited at different concentrations in the additive-containing alloy. In some embodiments, the additive-containing alloy comprises a first region comprising a first metal matrix phase present in a first matrix concentration and an additive phase present in a first additive concentration, wherein the additive phase comprises substantially spherical nanoscale particles that are substantially uniformly distributed within the metal matrix phase; and a second region having a second metal matrix phase present in a second matrix concentration that is different from the first matrix concentration, wherein each of the first metal matrix phase and the second metal matrix phase comprises equiaxed grains, wherein the equiaxed grains are substantially similar in size in each of the first and second metal matrix phase and/or wherein the equiaxed grains are substantially similar in size in both the first and second metal matrix phase. In embodiments where the substantially spherical nanoscale particles are substantially uniformly distributed, a majority of the substantially spherical nanoscale particles do not agglomerate at edges of the equiaxed grains of any corresponding metal matrix phase. In some embodiments, such additive-containing alloy embodiments can further comprising a second additive phase present in the second region, wherein the second additive phase has a second additive concentration different from the first additive concentration. In some embodiments, the second additive phase of the second region comprises substantially spherical nanoscale particles that are substantially uniformly distributed within the second metal matrix phase of the second region. In some embodiments, the concentrations can be different in the sense that they are higher than other concentrations or they are lower than other concentrations.

Also, some such additive-containing alloy embodiments can comprise one or more additional regions, wherein each additional region can comprise a metal matrix phase. In such embodiments, each of the one or more additional regions comprises an additive phase comprising substantially spherical nanoscale particles that are substantially uniformly distributed in each metal matrix phase of the one or more additional regions and wherein the additive phase has a concentration of the additive component that is different from that of the first additive concentration, the second additive concentration, or both the first additive concentration and the second additive concentration.

In some embodiments, the first additive phase and/or second additive phase of the first and second regions, respectively, can be present in an amount ranging from 0.01 and 2 wt %, such as 0.01 to 1.5 wt %, or 0.01 to 1 wt %, and the first metal matrix phase and/or second metal matrix phase makes-up the balance of each region. Also, a portion of the substantially spherical nanoscale particles of the additive phase are disposed in micron-scale particles within the metal matrix phase of the first region. In particular embodiments, the substantially spherical nanoscale particles have a size ranging from greater than 0 nm to 100 nm or less, such as 0.1 nm to 100 nm, or 0.1 nm to 80 nm, or 0.1 to 60 nm, or the like. In an independent embodiment, the metal matrix phase does not comprise substantially spherical nanoscale particles that have a size of 190 nm or greater (e.g., 200 nm to 1 μm). In some embodiments, the first additive phase can comprise an additive component that is chemically different from an additive component in the second additive phase (and/or any additional additive phases). In some embodiments, the alloy providing the first metal matrix phase can comprise different alloy elements than an alloy providing the second metal matrix phase (and/or any additional metal matrix phases).

In some embodiments, the alloy comprises mechanical properties that are superior to conventional alloys without an additive component or conventional additive-strengthened alloys prepared using ball-milling techniques, even after being exposed to high temperatures (e.g., temperatures above 600° C., such as 700° C. or higher, or 800° C. or higher). In some embodiments, the alloy exhibits a yield strength and/or tensile strength of 500 MPa to 800 MPa, such as 550 MPa to 775 MPa, or 550 MPa to 700 MPa, or 580 MPa to 680 MPa at ambient temperature. In some embodiments, the alloy exhibits a yield strength of 280 MPa to 295 MPa after thermal stress testing (e.g., exposing the alloy to a temperature of 600° C.). In some embodiments, the alloy exhibits a tensile strength of 360 MPa to 380 MPa after thermal stress testing (e.g., exposing the alloy to a temperature of 600° C.). In some embodiments, the alloy exhibits a yield strength of 145 MPa to 156 MPa after thermal stress testing (e.g., exposing the alloy to a temperature of 800° C.). In some embodiments, the alloy exhibits a tensile strength of 144 MPa to 157 MPa after thermal stress testing (e.g., exposing the alloy to a temperature of 800° C.).

As discussed herein, additive-containing alloy embodiments disclosed herein exhibit superior properties and possess unique structural features not found in alloys made using conventional ball-milling-based methods. Structural features of the additive-containing alloys can be evaluated using, for example, X-ray diffraction, optical, scanning and transmission electron microscopy. The properties of the additive-containing alloy embodiments disclosed herein can be evaluated using different tests, such as nanoindentation techniques, corrosion tests from ambient temperatures to 800° C., and high temperature mechanical testing (e.g., tensile, creep, and fatigue tests). Additionally, due to the ability to make additive-containing alloys comprising high concentrations of additive components that cannot be incorporated using conventional methods, even higher green densities and/or concentrations of secondary phases maybe possible, leading to products and components exhibiting improved mechanical and physical properties.

### V. OVERVIEW OF SEVERAL EMBODIMENTS

Disclosed herein are embodiments of an alloy comprising a metal matrix phase comprising equiaxed grains of a substantially uniform grain size and wherein the metal matrix phase is substantially free of columnar grains; and an additive phase comprising substantially spherical nanoscale particles and wherein a majority of the substantially spherical nanoscale particles are substantially uniformly distributed within the metal matrix phase and not at external boundaries of the metal matrix phase.

In any or all of the above embodiments, the additive phase is present between 0.01 wt % and 2 wt % and the metal matrix phase makes up a balance wt % of the alloy.

In any or all of the above embodiments, the metal matrix phase comprises a steel.

In any or all of the above embodiments, the steel comprises Fe, 18 wt % Cr, 8 wt % Ni, 2 wt % Mn, and 1 wt % Si.

In any or all of the above embodiments, the substantially spherical nanoscale particles of the additive phase comprise yttrium oxide.

In any or all of the above embodiments, the alloy, having been exposed to heat, exhibits a mechanical property profile providing (i) a yield strength of 280 MPa to 295 MPa after heating at 600° C.; or (ii) a tensile strength of 360 MPa to 380 MPa after heating at 600° C.

Also disclosed herein are embodiments of an alloy comprising a first region comprising a first metal matrix phase present in a first matrix concentration and an additive phase present in a first additive concentration, wherein the additive phase comprises substantially spherical nanoscale particles that are substantially uniformly distributed within the metal matrix phase; and a second region having a second metal matrix phase present in a second matrix concentration that is different from the first matrix concentration; wherein each of the first metal matrix phase and the second metal matrix phase independently comprises equiaxed grains and each of the first metal matrix phase and the second metal matrix phase independently are substantially free of columnar grains.

In any or all of the above embodiments, the alloy further comprises a second additive phase present in the second region, wherein the second additive phase has a second additive concentration that is different from the first additive concentration.

In any or all of the above embodiments, the second additive phase of the second region comprises substantially spherical nanoscale particles that are substantially uniformly distributed within the second metal matrix phase of the second region.

In any or all of the above embodiments, a portion of the substantially spherical nanoscale particles of the additive phase are disposed in micron-scale particles within the metal matrix phase of the first region and wherein the metal matrix phase comprises Fe, 18 wt % Cr, 8 wt % Ni, 2 wt % Mn, and 1 wt % Si and the additive is yttrium oxide.

In any or all of the above embodiments, the alloy further comprises one or more additional regions, wherein each additional region comprises a metal matrix phase and an additive phase comprising substantially spherical nanoscale particles that are substantially uniformly distributed in each metal matrix phase of the one or more additional regions and wherein the additive phase of the one or more additional regions has a concentration that is different from that of the first additive concentration, the second additive concentration, or both the first additive concentration and the second additive concentration.

Also disclosed herein are embodiments of a method comprising: adding one or more feedstock powders comprising a metal alloy or a metal alloy mixed with an additive component to a laser powder bed; selectively depositing one or more additive-containing solutions, one or more additive precursor-contaiinf containing solutions, or a combination thereof in the laser powder bed; and cladding a mixture provided by (i) the one or more feedstock powders and (ii) the one or more additive-containing solutions, the one or more additive precursor-containing solutions, or the combination thereof using a laser operated at a power sufficient to sinter or melt the mixture.

In any or all of the above embodiments, the one or more feedstock powders are added to the laser powder bed before depositing the one or more additive-containing solutions or the one or more additive precursor-containing solutions in the laser powder bed.

In any or all of the above embodiments, the one or more feedstock powders are added to the laser powder bed after depositing the one or more additive-containing solutions or the one or more additive precursor-containing solutions in the laser powder bed.

In any or all of the above embodiments, selectively depositing comprises adding the one or more additive-containing solutions or the one or more additive precursor-containing solutions in the laser powder bed at a pre-determined region of the laser powder bed or adding a pre-determined concentration of the one or more additive-containing solutions or the one or more additive precursor-containing solutions to the laser powder bed.

In any or all of the above embodiments, a computer program is used to selectively deposit the one or more additive-containing solutions or the one or more additive precursor-containing solutions in the laser powder bed in particular locations and/or at particular concentrations pre-determined by the computer program.

In any or all of the above embodiments, a plurality of selective deposition steps are performed with different concentrations of the one or more additive-containing solutions or the one or more additive precursor-containing solutions so as to provide an additive-containing alloy product having regions of that have different concentrations of an additive component provided by the one or more additive-containing solutions or the one or more additive precursor-containing solutions.

In any or all of the above embodiments, the method further comprises sintering an additive component provided by the one or more additive-containing solutions or the one or more additive precursor-containing solutions after selectively depositing the one or more additive-containing solutions or the one or more additive precursor-containing solutions, wherein sintering comprises heating using a laser operated at a power lower than a power used in cladding the mixture.

In any or all of the above embodiments, cladding promotes rearrangement and/or dispersion of an additive component of the one or more additive-containing solutions or the one or more additive precursor-containing solutions into a metal matrix formed by cladding the metal alloy in the laser powder bed.

In any or all of the above embodiments, the method comprises selectively depositing an additive precursor-containing solution comprising Y(NO₃)₃, urea, and an alcohol; and wherein the feedstock comprising the metal alloy is a stainless steel feedstock powder and wherein cladding the mixture provided by the feedstock and the additive precursor-containing solution comprises exposing thec stainless steel feedstock powder and the additive precursor-containing solution to a laser operated at a power ranging from 100 W to 150 W.

In any or all of the above embodiments, the method further comprises sintering an additive component provided by the one or more additive-containing solutions or the one or more additive precursor-containing solutions after selectively depositing the one or more additive-containing solutions or the one or more additive precursor-containing solutions, wherein sintering comprises heating using a laser operated at a power lower than a power used in cladding the mixture.

### VI. EXAMPLES

### Example 1

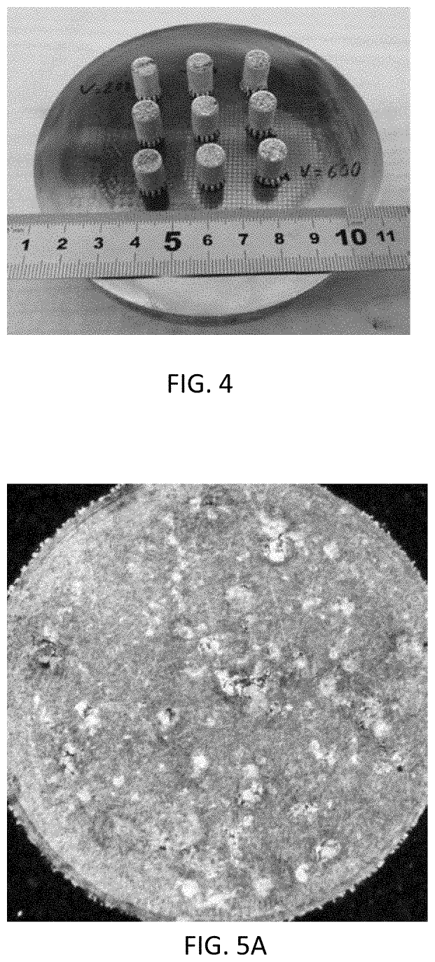

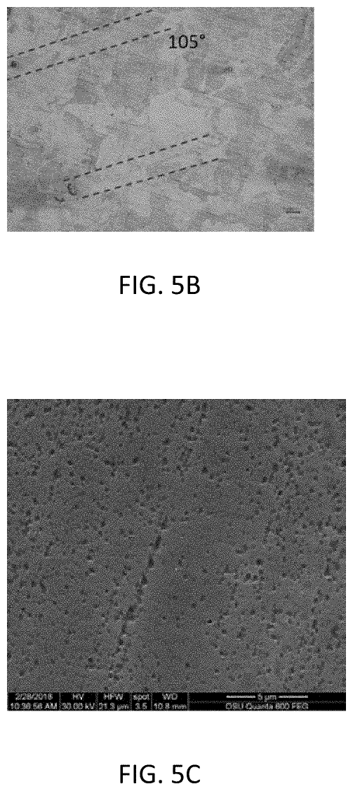

In this example, the ability of a hybrid metal laser powder bed fusion method embodiment to make an additive-containing alloy was evaluated. Nine cylinders of 304 stainless steel with radius of nominally 8 mm were printed as shown in FIG. 4. After removing the cylinders from the base plate, the density of the material was measured using Archimedes' method. Based on density measurements of the LPBF 304 stainless steel, it was found that increasing the speed to more than 300 mm/s decreased the density of the printed cylinders. Although the 50 mm/s cylinders had the highest density, they showed less dimensional accuracy and had very rough surfaces due to excessive melting. FIG. 5A, shows the cross section of 304 stainless steel specimens printed with a scan speed of 600 mm/s at low magnification. FIG. 5B shows a polished micro-structure of 304 stainless steel using optical microscopy showing very small (<1 μm) porosities in the metal matrix phase and evidence of the laser path (dashed lines). After polishing and etching a cross-section of 304 stainless steel with Fry's reagent, small voids (where HCl dissolved the ferrite matrix) are observed showing directionality in the interior of the grain (FIG. 5C).

To produce the additive-containing 304 stainless steel samples for comparison, a planetary ball mill with 500 ml stainless steel jar and a ball size of 10 mm was used to mix the powder. Ball-milling parameters included a ball-to-powder ratio of 5:1 and a ball-milling time of 4 hours within a nitrogen atmosphere. Each batch weighed 100 grams. Powder particle size was 45(−10) μm for 304 stainless steel and <1 μm for yttria. Powder characteristics were measured including apparent density, tap density and Hausner ratio for 304 stainless steel powder and 304 stainless steel +5 wt % yttria as shown in Table

TABLE 1
Physical properties of 304
powder and 304 + 5 wt % yttria after mixing.

| Powder characteristics | 304 Powder | 304 + 5 wt % yttria |
|---|---|---|
| Apparent density (AD) | 3.59 gr/cm3 | 3.53 gr/cm3 |
| Tap density (TD) | 4.69 gr/cm3 | 4.58 gr/cm3 |
| Hausner ratio | 1.31 | 1.30 |

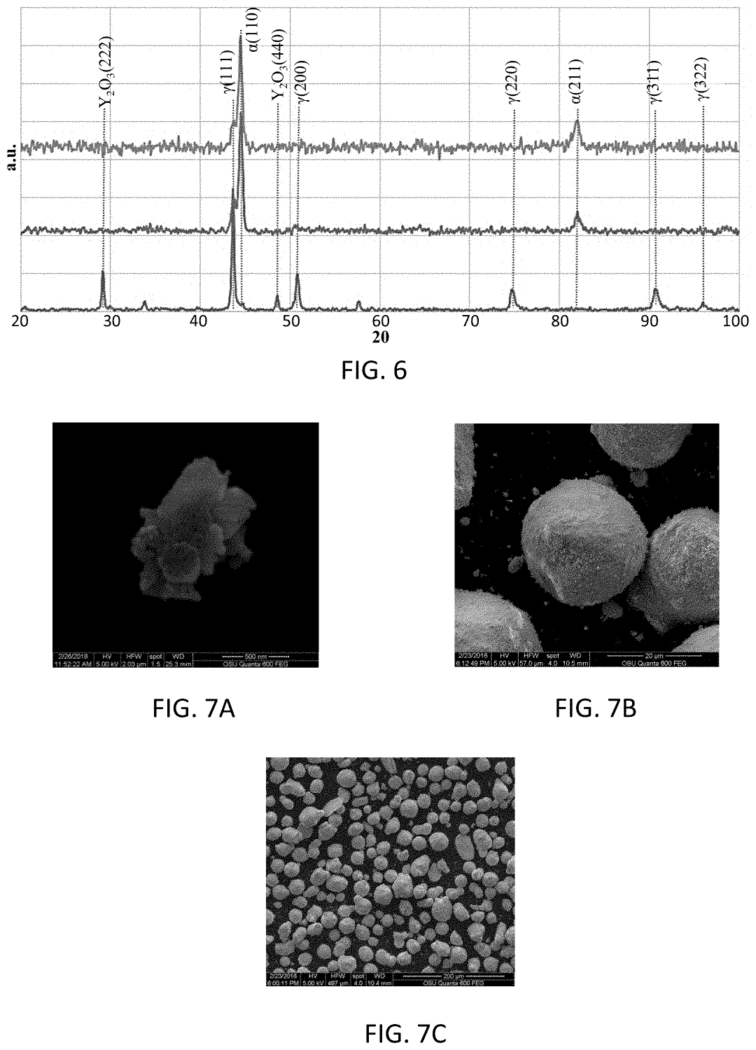

The XRD results from the mixed powder confirm that the yttria particles do not dissociate in the metal matrix phase and instead exhibit a uniform mixing. In particular, FIG. 6, shows the XRD results obtained from laser powder bed fusing 304 stainless steel and 304 stainless steel with 5 wt % yttria. Austenite and ferrite phase are dominate phases. Adding the yttria particles did not change the phases in the metal matrix phase. FIG. 7A shows that the initial yttria particles have an irregular shape, and FIGS. 7B and 7C show that the yttria-containing stainless steel comprises small particles of yttria-coated 304 stainless steel powder. As can be seen in FIGS. 7B and 7C, the morphology of the 304 stainless steel powder retained a spherical shape indicating that there was no occurrence of mechanical alloying during the 4 hours of ball-milling.

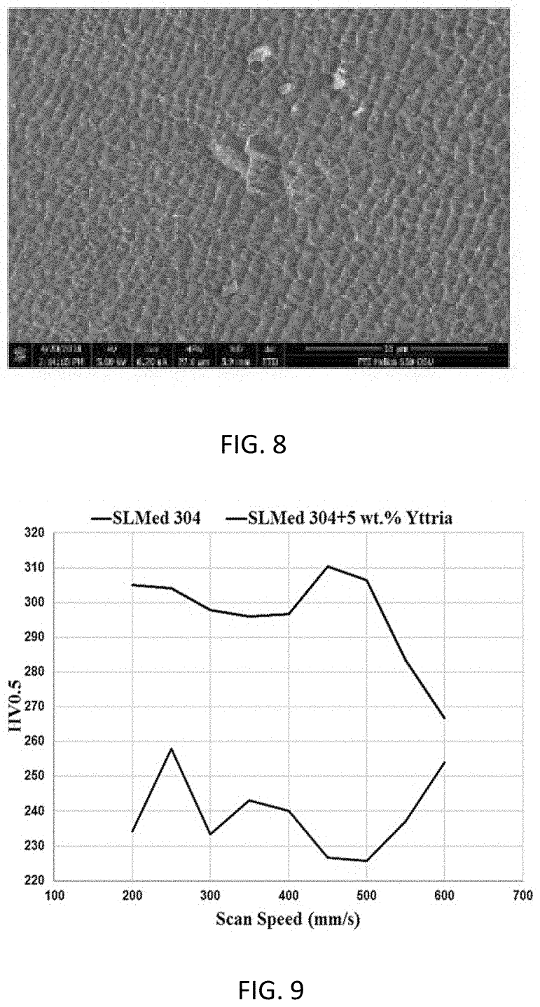

A SEM micrographs of the additive-containing alloy produced with the mixed powder and yttria nanoparticles is shown in FIGS. 3B and FIG. 8. The micrographs show the precipitation of very small (10-70 nm) and an additive phase of spherical particles of yttria dispersed throughout the 304 stainless steel matrix phase. Evidence of cellular substructures can be seen in FIG. 3B, which is the typical substructure produced with laser powder bed fusion of 304 stainless steel. The morphology and size of the yttria after the laser powder bed fusion method changed significantly. Without being limited to a particular theory, it currently is believed that this may be attributed to the melting of yttria during the laser powder bed fusion process. Although, the melting point of yttria is 2425° C., the small size of these particles (e.g., <1 μm) could potentially lower the melting point of yttria. Comparing the surface area of yttria particles with beam diameter (˜50 μm), it is possible that the laser energy is sufficient to melt and precipitate the yttria. EDS chemical result analysis from these small particles confirmed the formation of yttrium reach nanoparticles (see Table 2, below).

TABLE 2
EDS results

| Element | Wt % |
|---|---|
| OK | 3.00 |
| NiL | 5.12 |
| SiK | 0.92 |
| YL | 2.87 |
| CrK | 18.92 |
| MnK | 1.69 |
| FeK | 67.46 |
| Total | 100.00 |

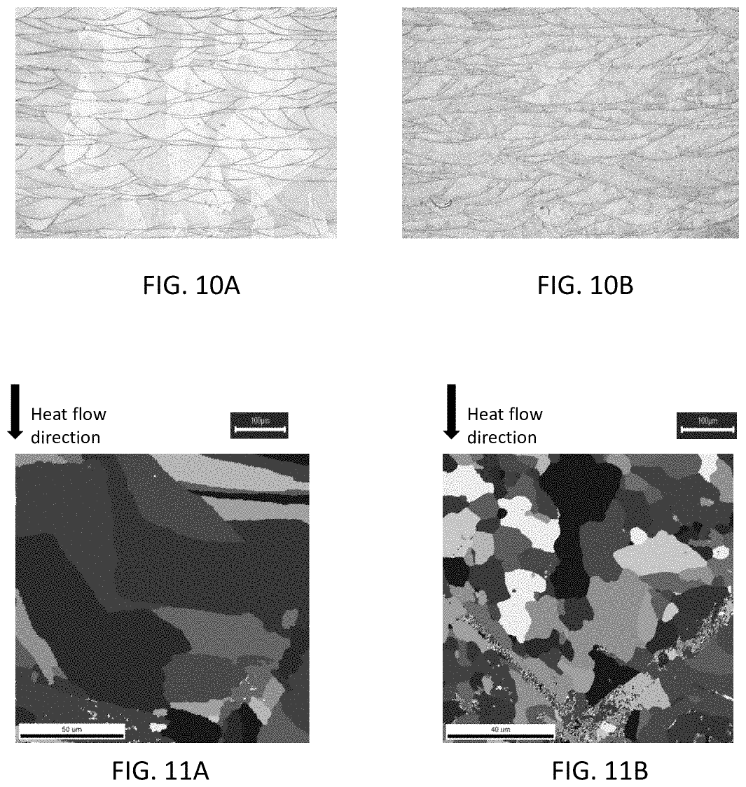

Adding nanoparticles of yttria increased the hardness of sample by 30% (and even as high as 38% for some embodiments) as evidenced by FIG. 9. Some Vickers hardness average values increased from 225 HV to 310 HV. This increase in hardness may be attributed to the changing of the typical columnar grains of 304 stainless steel to more equiaxed grains in the embodiments comprising 5 wt % yttria. Representative optical micrographs are provided by FIGS. 10A and 10B, which show comparative microstructures of 304 stainless steel without the yttria additive (FIG. 10A, which shows columnar grains) and with the yttria additive (FIG. 10B, which shows more equiaxed grains).

The EBSD results, shown in FIGS. 11A and 11B, show that the grain size in the laser powder bed fused stainless steel comprising 5 wt % yttria significantly decreased (as can be seen by comparing FIG. 11A, which shows larger grain sizes, with FIG. 11 B, which shows must smaller grain sizes). The yttria particles can act as an inoculant and facilitate the heterogeneous nucleation leading to grain refinement and increase in hardness values. Another reason for increase in hardness is due to dispersion mechanism as nanoparticles would work as barriers for dislocation movement and would pin dislocations.

### Example 2

In this example, an alloy embodiment comprising ODS 304 stainless steel with only 0.5 wt % yttria was made to evaluate whether the alloy exhibits desirable properties (e.g., strength, creep resistance, thermal fatigue resistance, and/or oxidation resistance) such that it can be used in products exposed to high temperatures (e.g., high temperature recuperators and the like). A feedstock powder was prepared by mixing 304 stainless steel powder with 0.5 wt % yttria in a planetary ball mill for 4 hours with a ball-to-powder ratio of 5:1 under a nitrogen atmosphere. A majority of the powder particles were spherical and covered by very fine yttria particles.

The mixed powder was used as the feedstock for laser powder bed fusion using an OR Creator SLM machine. Different scan speeds were adopted to produce small cylinders with the size of R4×8 mm. The conditions used were as follows: a laser power of 105 W, a scan speed ranging from 200 to 600 mm/s, layer thickness of 30 μm, spot size of 50 μm and hatch spacing of 50 μm. The as-fabricated cylinders were cross-sectioned to measure the density and micro-hardness. Cross-sections were electroetched for further characterization by SEM.

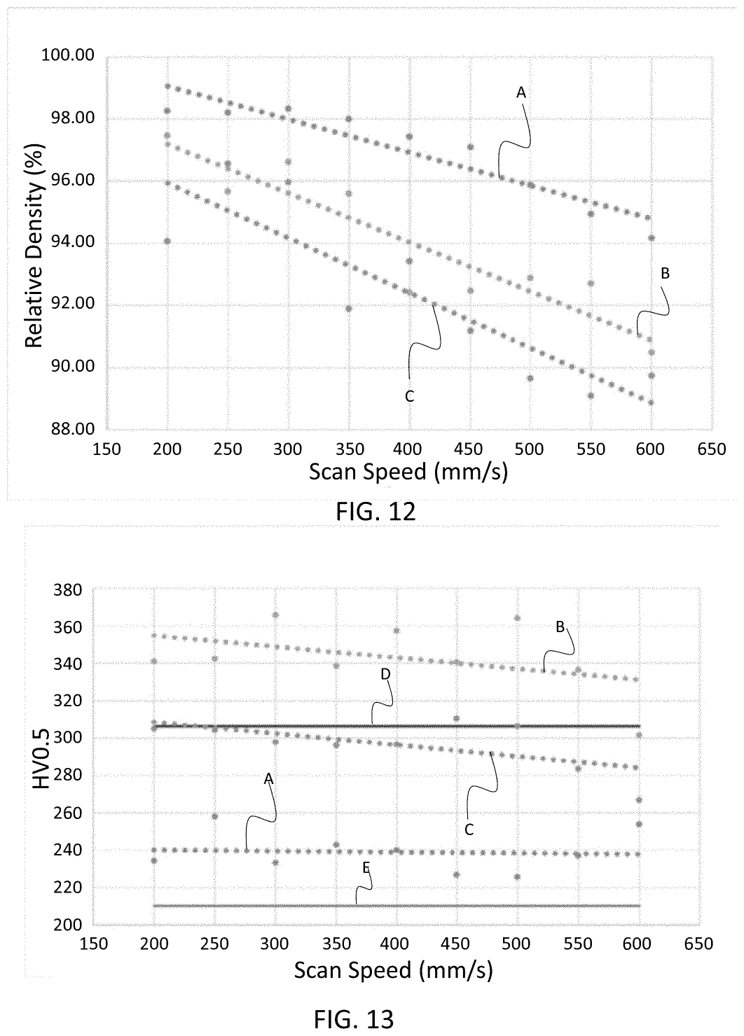

Density and microhardness of the laser powder bed fused 304 stainless steel comprising 0.5 wt % yttria were measured and results are shown in FIGS. 12 and 13. For comparison, the relative density and micro-hardness of laser powder bed fused 304 stainless steel without any additive and laser powder bed fused 304 stainless steel comprising 5 wt % yttria were also analyzed.

As shown in FIG. 12, by increasing the scan speed, the relative density dropped. Without being limited to a single theory, it currently is believed that this may be attributed to the existence of lack-of-fusion voids due to lower volumetric energy density. Further, the laser powder bed fused 304 stainless steel and the laser powder bed fused 304 stainless steel comprising 0.5 wt % yttria shows higher density compared to the laser powder bed fused 304 stainless steel comprising 5 wt % yttria. Again, without being limited to a single theory, it currently is believed that this is in part due to the yttria hindering the uniform layering of powder, and the non-uniform layering resulting in more lack-of-fusion porosity and lower density in the manufactured part. The highest relative density for laser powder bed fused 304 stainless steel, laser powder bed fused 304 stainless steel comprising 0.5 wt %, and laser powder bed fused 304 stainless steel comprising 5 wt % yttria were 99%, 98%, and 96%, respectively. The room temperature microhardness value, see FIG. 13, of laser powder bed fused 304 stainless steel comprising 0.5 wt % yttria shows an increase in hardness of about 50% compared to laser powder bed fused 304 stainless steel and about 20% increase compared to laser powder bed fused 304 stainless steel comprising 5 wt % yttria. Additionally, the laser powder bed fused 304 stainless steel comprising 0.5 wt % yttria shows significantly higher hardness (340-367 HV) compared to wrought 304 stainless steel hardness (210 HV) and a moderately higher value compared to austenitic 316 stainless steel alloy (306 HV) which was produced by spark plasma sintering (SPS).

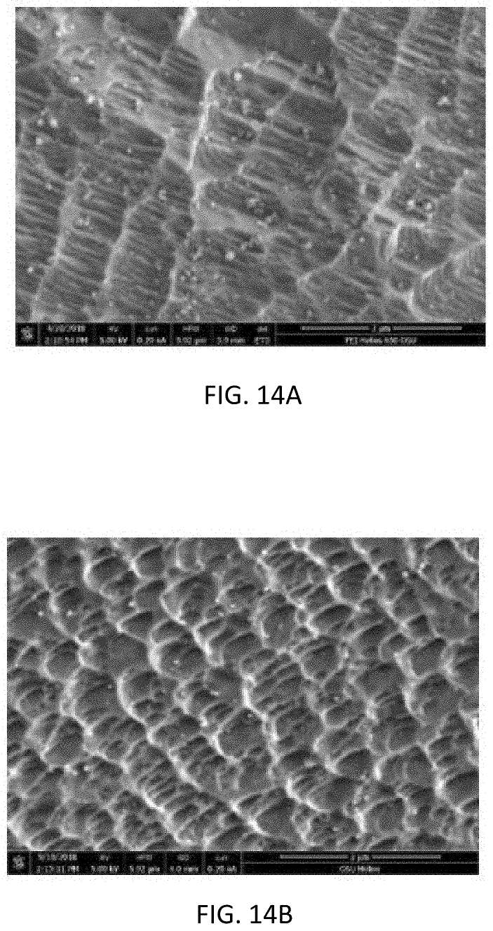

Further investigation by SEM, as shown in FIGS. 14A and 14B, revealed the formation of fine nanoparticles and their uniform distribution as an additive phase within a metal matrix phase. Samples scanned at 400 mm/s showed finer nanoparticles with more uniform distribution within the metal matrix phase in laser powder bed fused 304 stainless steel comprising 0.5 wt % yttria (FIG. 14B) than in the metal matrix phase in laser powder bed fused 304 stainless steel comprising 5 wt % yttria (FIG. 14A). The higher hardness value in laser powder bed fused 304 stainless steel comprising 0.5 wt % yttria samples may be attributed to the combined effect of higher density and finer, more homogenously distributed nanoparticles. This example shows that the use of 0.5 wt % yttria can significantly improve the room temperature mechanical properties of 304 stainless steel.

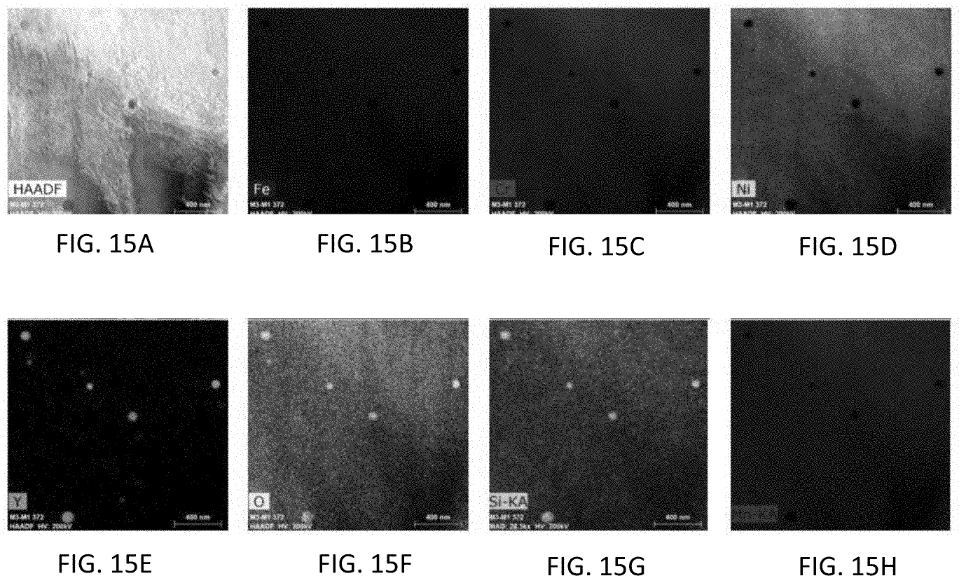

FIGS. 15A-15H show STEM micrographs of the 0.5 wt % microstructure showing nanoparticles (FIG. 15A) along with corresponding EDS maps (FIGS. 15B-15H). According to the EDS analysis, the nanoparticles are a compound of yttrium, silicon and oxygen which is more stable at high temperatures compared to yttrium oxide.

### Example 3

In this example, a single-layer laser cladding step was performed using gas-atomized 316L and 304L stainless steel powder with a mean particle size of 30 μm. A single layer of powder with a constant thickness of 75 μm was deposited onto a 316L stainless steel substrate. The powder layer was then exposed to a total of 4 wt % yttria, which was deposited into the powder bed via 20 raster scan cycles of jetting the nanoyttria suspension. Next, the laser was raster scanned over the powder layer containing the jetted nanoparticles. Then, the bed was irradiated using an infrared laser. The presence of yttria particles in the product was confirmed by XRD analysis.

### Example 4

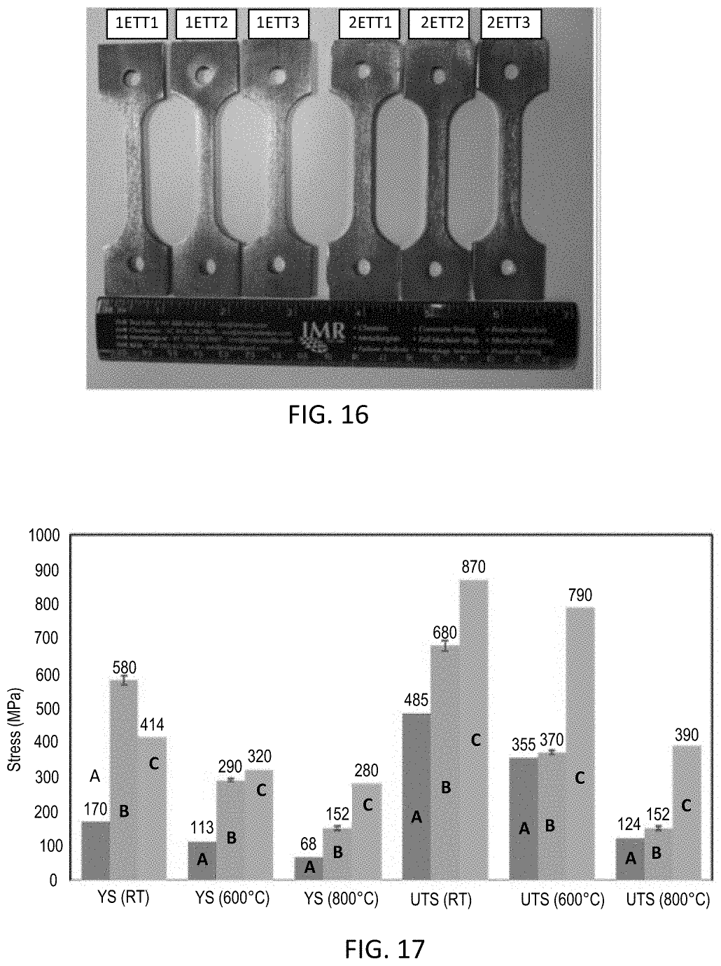

In this example, alloy embodiments comprising 304L stainless steel and 0.5 wt % yittria were evaluated and characterized. A relative density of 99% was produced by ball-milling and laser powder bed fusion using OR Creator selective laser melting (SLM) equipment. Three tensile bars were produced with dimensions of 100×10×8 mm for room temperature and six tensile bars were produced of 100×25×8 mm for high temperature tensile testing (FIG. 16). The printed bars were cut out of SLM coupons using wire electrical discharge machining (EDM) according to the ASTM E8 standard.

Tensile tests were conducted at room temperature, 600° C., and 800° C. with a strain rate of 10⁻⁴ S⁻¹. FIG. 17 compares the room temperature, 600° C. and 800° C. yield strength (YS) and ultimate tensile strength (UTS) of 304L stainless steel comprising 0.5 wt % yittria with annealed 304L stainless steel and Inconel 625 solution annealed at 1093° C. At room temperature, the YS and UTS of the 304L stainless steel comprising 0.5 wt % yittria alloy were 580 and 680 MPa, respectively, which are 240% and 40% higher than the YS and UTS of the annealed 304L stainless steel and 40% higher than the YS of Inconel 625.

The YS of 304L stainless steel comprising 0.5 wt % yittria was 290 and 152 MPa at temperatures of 600° C. and 800° C., respectively, which when compared with annealed 304L stainless steel shows an increase of about 150% and 120%, respectively. The comparison of the UTS values of annealed 304L stainless steel and SLM ODS 304L stainless steel at high temperatures was similar.

Comparing the tensile properties of 304L stainless steel comprising 0.5 wt % yittria and Inconel 625 at T=600° C., the YS of the ODS alloy is 290 MPa, which is 90% of the YS of Inconel 625. At T=800° C., the YS of ODS alloy was 152 MPa, about 54% of the YS of Inconel 625. The reported tensile properties at high temperatures suggest that the 304L stainless steel comprising 0.5 wt % yittria has the potential to replace Inconel 625 at the operating temperature of the HTR.

### Example 5

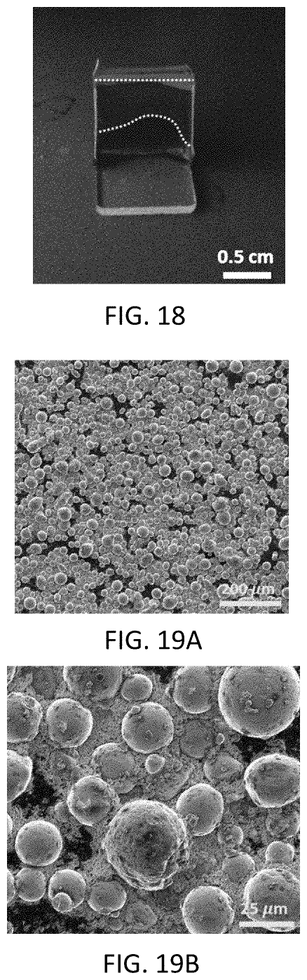

In this example, the jetting and wicking behavior of the yttria solution into the powder bed and its effect on the distribution of yttria particles was evaluated. In particular, a 20 wt % suspension of 10 nm Y₂O₃ nanoparticles in ethanol was used. Ethylene glycol was added to control viscosity for jetting. To investigate the ink wicking performance in the stainless steel powder, 10 nm YVO₄:Eu fluorescent nanoparticles were added to the same ethanol:ethylene glycol concentration and printed into a stainless steel powder bed packed within a 1×1×0.004 cm fused glass holder. By shining 275 nm UV light into the powder bed, the fluorescence provides an indication of the penetration pattern of the nanoparticles as shown in FIG. 18. This image suggests good wicking of the ink into the powder bed. Further, in FIGS. 19A and 19B, stainless steel powder was layered to a thickness of that used in LPBF and placed onto carbon tape. Next the yttria nanoparticle suspension was jetted into the powder bed under the same conditions as used to produce the 0.5 wt % yttria in 304 stainless steel. The tape helped to drain the charge from the sample while doing SEM analysis. These images show good penetration into the powder bed.

### Example 6

In this example, the use of a yttria precursor as additive precursor was evaluated. A solution comprising yttrium hydroxide Y(OH)₃ nanoparticles was developed and dispersed in a zero-carbon chemistry. The Y(OH)₃ can be fully converted to Y₂O₃ when exposed to temperatures above 500° C. The Y(OH)3 nanoparticles were produced by precipitation by adding alkaline solution (ammonium hydroxide) into an aqueous solution of Y(NO₃)₃. The precipitated Y(OH)₃ nanoparticles were washed by the alkaline solution and deionized (DI) water three times. The washed Y(OH)₃ nanoparticles were found to suspend in ethanol for six hours after which they can be re-dispersed by ultrasonication. The obtained Y(OH)₃ suspension was successfully printed onto the stainless steel substrate using an airbrush nozzle.

### Example 7

In this example, a low-cost method to produce Y₂O₃ nanoparticle suspensions were evaluated to improve the ability to dispense the nanoparticles without clogging machinery improve their suspension in an ink without a ligand shell to minimize contamination effects to the alloy composition. In some embodiments, the printable ink can comprise a 1 wt % suspension of 10 nm Y₂O₃ nanoparticles in ethanol and ethylene glycol.

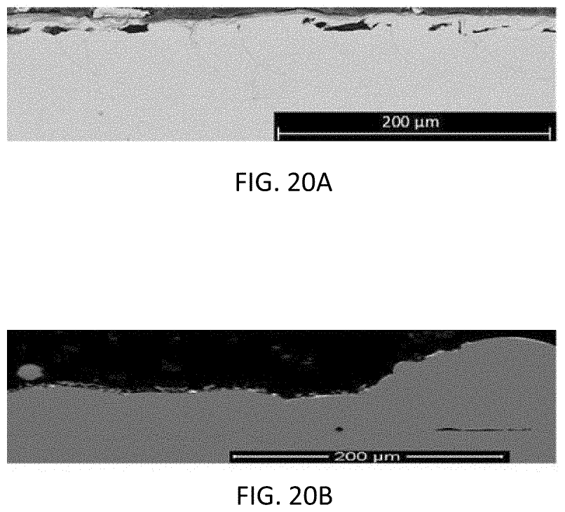

Also examined in this example were compositions comprising 0.5 wt % loading of the yttria nanoparticles within the powder bed. In some samples, pores were created in the additive-containing alloy, likely due to solvent effects and the agglomeration of NPs that floated to the top of the weld pool before solidification and fell out of the clad layer during metallography (see FIG. 20A). In order to reduce gas porosity, the solvent was evaporated out of the powder bed before laser cladding. As shown in FIG. 20B, gas porosity was eliminated by ensuring that the ethanol solvent was substantially evaporated from the powder bed prior to laser cladding. Further, to reduce NP agglomeration, the nanoparticles were irradiated with a low energy density scan to sinter them to the substrate, followed by layering and laser cladding of a 304L stainless steel powder bed. FIG. 20B also shows that this procedure eliminated the larger pores at the top of the laser cladding.

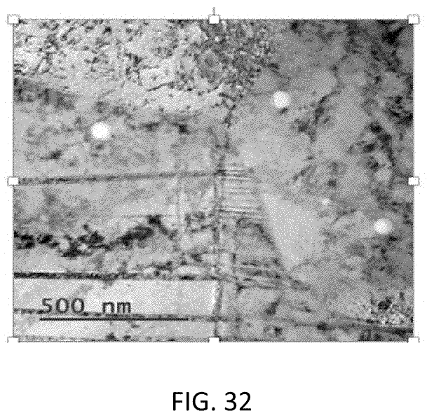

In yet additional examples, a 304 stainless steel feedstock powder was doped by selectively depositing up to 1.2 wt % of Y₂O₃ (having an average particle size of 10 nm) from an additive-containing solution into a powder bed comprising the feedstock powder, followed by laser cladding. The yttria particles were successfully distributed in the powder bed prior to cladding and were redistributed in the metal matrix phase in situ during the cladding step. A TEM bright field image of the resulting additive-containing alloy is shown in FIG. 32. FIG. 32 shows that the additive-containing alloy comprises equiaxed grains, nano-sized porosity and band-type features.

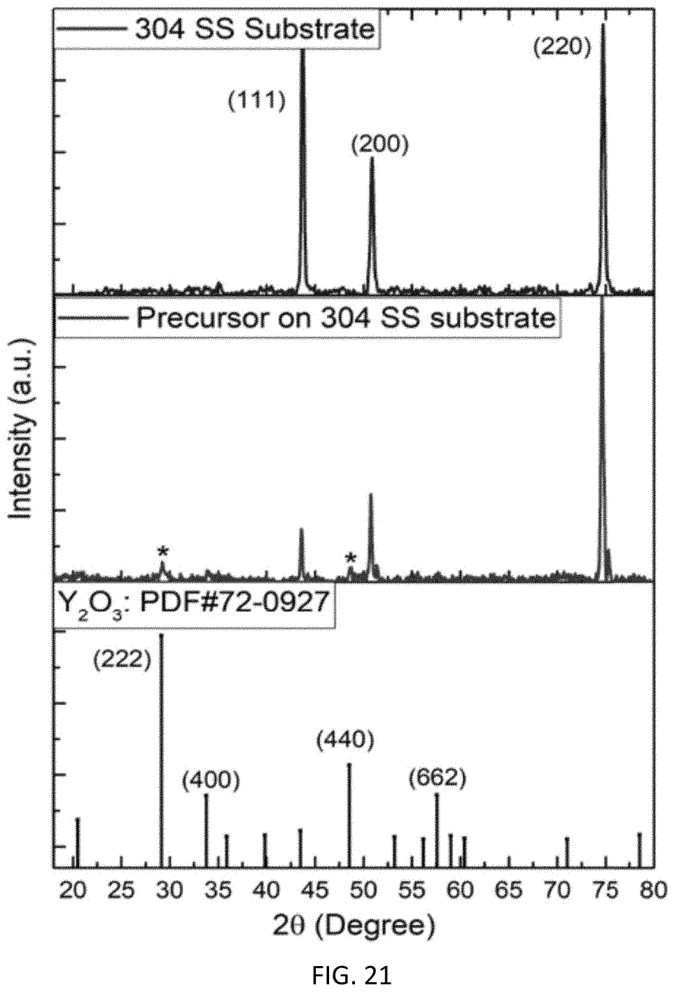

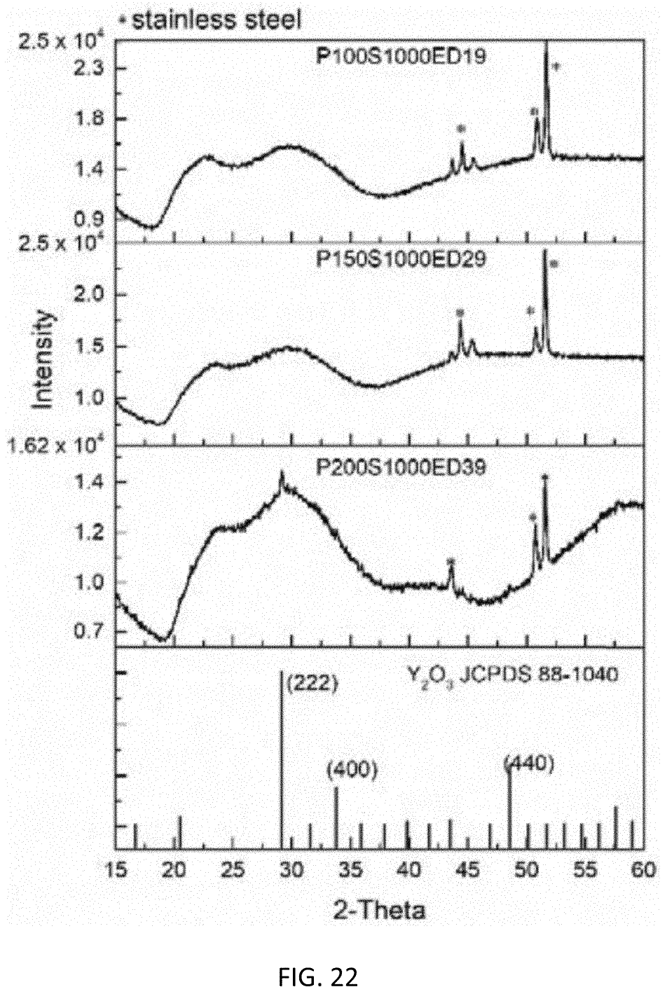

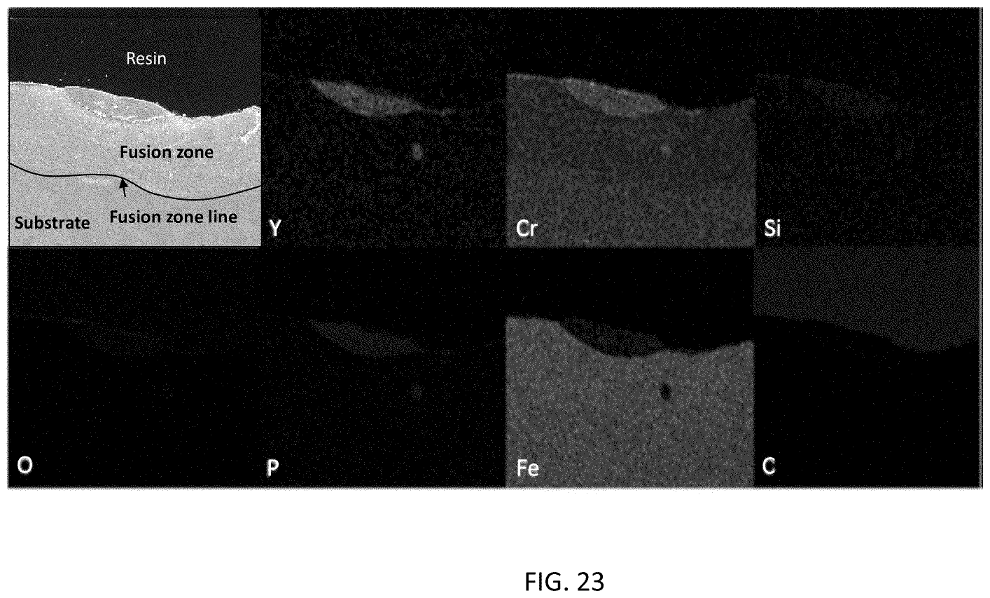

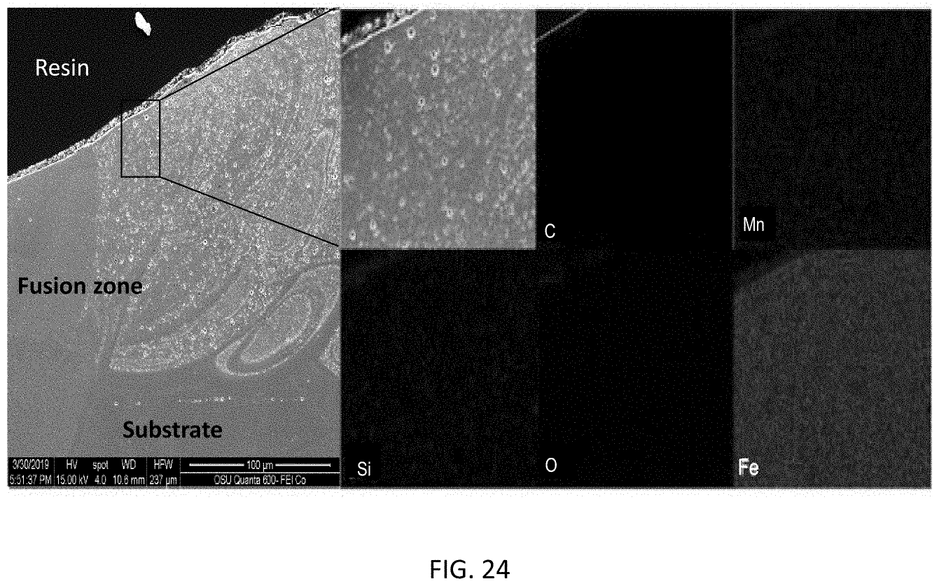

A precursor strategy was identified for increasing the effective solids loading in the ink by converting a molecular chemistry to nanoparticles within the bed. The reaction involves Y(NO₃)₃ and urea resulting in yttria and various benign gaseous by-products. This route provided a printable ink across a wide range of nanoparticle concentrations with greater solids loading in the stainless steel powder bed without the disadvantages of clogging machinery during deposition. Additionally, the liquid form of the precursor can easily penetrate and evenly cover the stainless steel powder yielding an even more uniform distribution of yttrium in the final bulk material. Aqueous Y(NO₃)₃ and urea inks were formulated and inkjet printed onto stainless steel substrate and subjected to laser cladding. XRD data (see FIG. 21) indicated the formation of Y₂O₃ after laser cladding. Also, the XRD pattern in FIG. 22 (top spectrum labeled P100S1000ED19) shows that the (222) peak of the standard cubic phase Y₂O₃ appeared when using a laser energy density of 39 J/mm2 at a laser power of 200 W and a scan speed of 1000 mm/s (see FIG. 22, middle spectrum labeled P150S1000ED29). No significant yttria peaks were observed at lower laser energy densities. SEM cross-sectional images (see FIGS. 23 and 24) show that no thick carbon layer is formed in the samples prepared from the precursor-based inks. These results suggests that all carbon-containing chemicals in the molecular precursor-based ink were consumed and/or removed as gaseous by-products prior to solidification.

### Example 8

In this example, the performance of a printable ink comprising yttria was evaluated, particularly with respect to the ability to provide fast solvent evaporation; solid loading of a yttria precursor (e.g., Y(NO₃)₃) in the ink at a value of 30 wt %; and minimal to no zero carbon contamination to the stainless steel. Methanol which has higher solubility with Y(NO₃)₃ and vapor pressure compared to ethanol was used. Urea was removed avoid any possible carbon contamination.

The thermal decomposition of the methanol-based ink can be described by the chemical equation below.

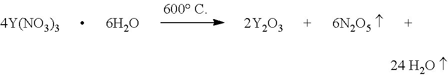

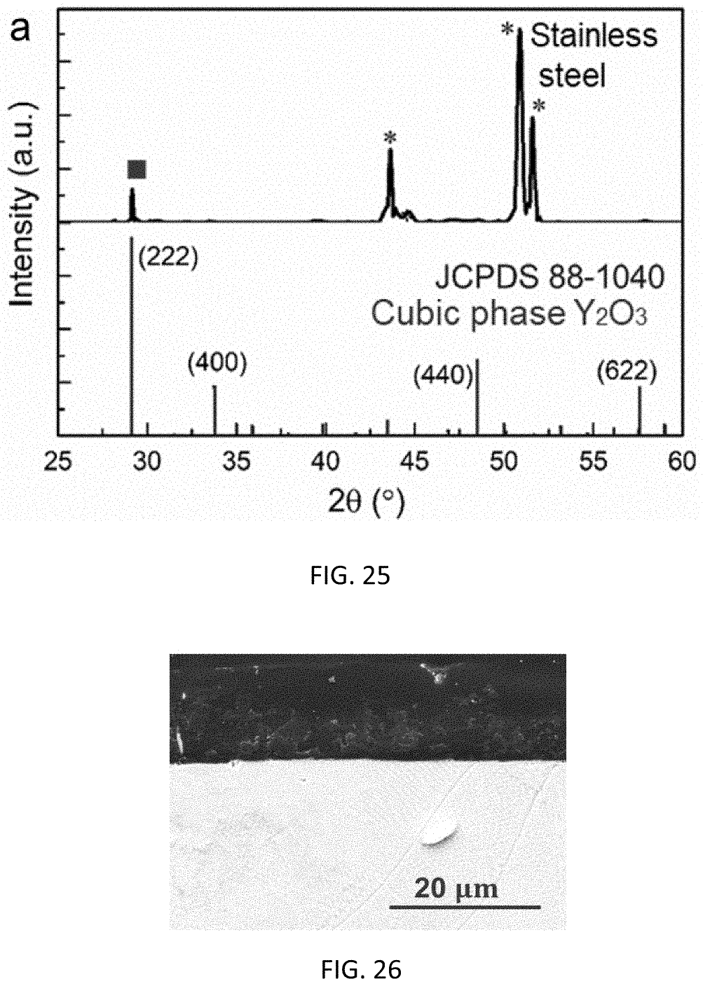

FIG. 25 shows an X-ray diffraction (XRD) plot for thermal decomposition experiments conducted in this example. The yttria peak at 29° (marked by the red square) appeared after baking the precursor at 600° C. for 1 hour. FIG. 26 shows that no carbon layer is observed when laser cladding the pure solvent (prior source of carbon contamination) used in the present ink recipe.

To identify laser parameters for the chemical reaction, the thermal conversion of the methanol-based ink in terms of the laser energy was studied with different combinations of laser power and scan speed was evaluated. The ink was deposited in sufficient quantity on the stainless steel 304 substrate in order to detect conversion via XRD. After ink deposition, the sample was preheated to 100° C. for 12 hours to ensure solvent removal. Then laser energy was applied for ink conversion.

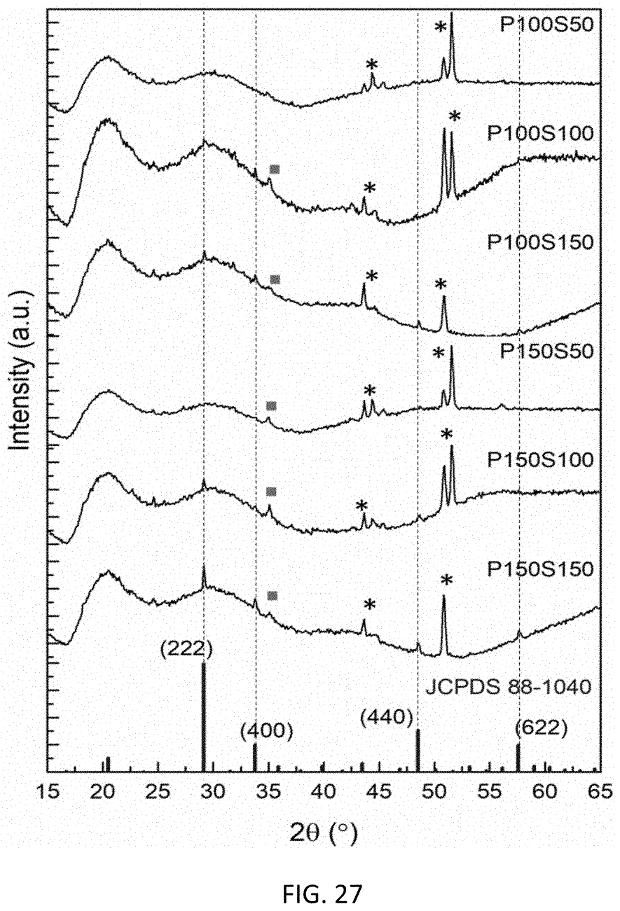

FIG. 27 is an XRD spectrum showing results from different scan speeds of the laser. The “P” and “S” of the sample labels in FIG. 27 represent laser power (W) and scan speed (mm/s), respectively. Larger yttria peaks of (222), (400), and (440) were detected when applying scan speeds of 100 and 150 mm/s. Higher laser power (150 W) results in larger peaks across the scan speeds. Higher scan speed (150 mm/s) seems to result in larger yttria peaks, which is not intuitive since slower scan speed should contribute to higher energy density and more conversion of yttria precursor. But the plot shows that as scan speeds descend below 150 mm/s, the strength of the yttria diffraction peaks diminishes (FIG. 27). Without being limited to a particular theory, it currently is believed that this result might be due to the better Marangoni mixing, which increases at higher energy densities for laser powder bed fusion, which could lead to the yttria becoming more embedded within the sample causing diminished XRD peaks. A small peak at 35° indicates a secondary oxide and is marked by the “▪” symbol in FIG. 27.

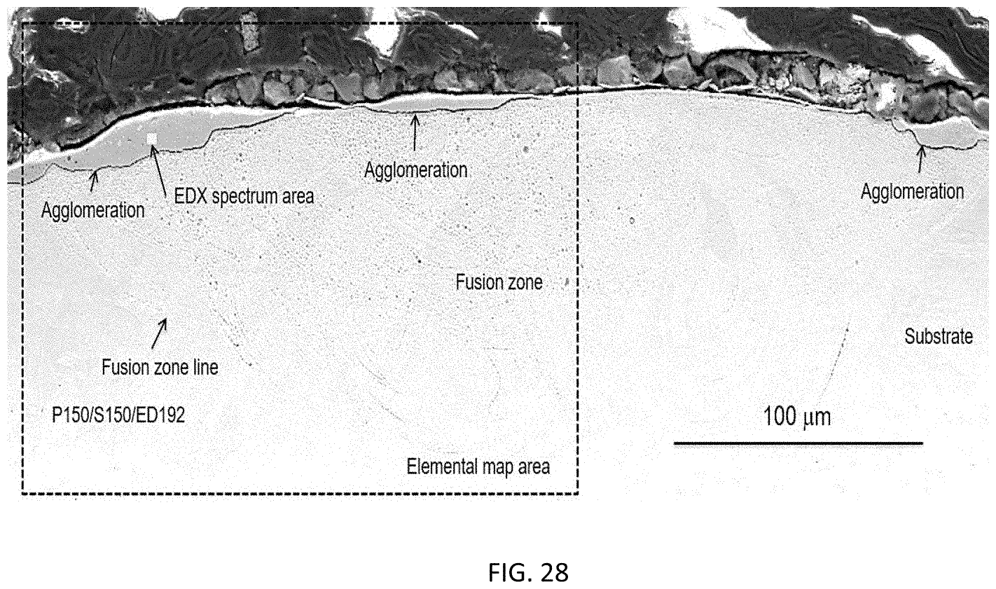

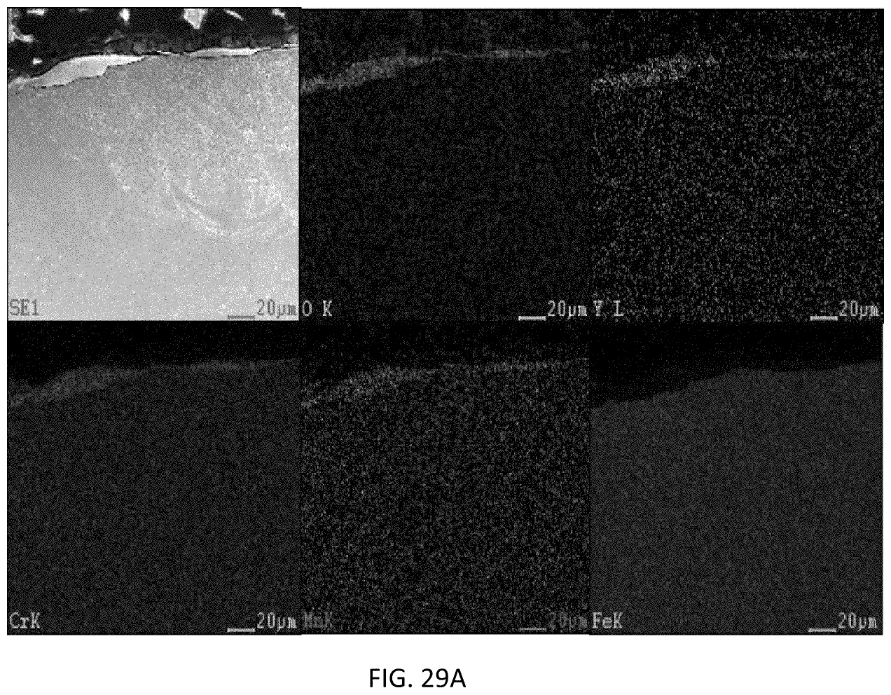

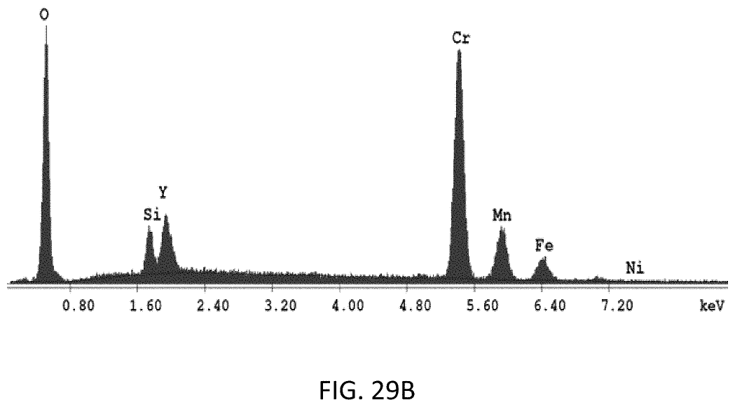

Subsequently, the samples were sectioned to investigate the distribution of yttria. FIG. 28 and FIGS. 29A and 29B show the cross-sectional microstructure as well as the energy dispersive X-ray spectroscopy (EDS) elemental maps (FIG. 29A) and spectrum analysis of sample P150/S150/ED192 (FIG. 29B). EDS results also are provided in Table 3. Based on the cross-sectional microstructure, some samples exhibited a second phase agglomeration consisting of 82 at % chromium and oxygen on the surface suggesting chromium oxide formation. Similar agglomerations were found inhomogeneously distributed on the surface of some samples.

TABLE 3

| Element | Wt % | At % | K-Ratio | Z | A | F |
|---|---|---|---|---|---|---|
| O K | 19.49 | 44.65 | 0.1241 | 1.1449 | 0.5546 | 1.0027 |
| SiK | 2.49 | 3.25 | 0.0198 | 1.1014 | 0.7183 | 1.0037 |
| Y L | 7.54 | 3.11 | 0.0568 | 0.8667 | 0.8667 | 1.0021 |
| CrK | 54.72 | 38.58 | 0.5304 | 0.9624 | 0.9965 | 1.0106 |
| MnK | 7.31 | 4.88 | 0.0690 | 0.9444 | 0.9993 | 1.0003 |
| FeK | 8.19 | 5.38 | 0.0755 | 0.9615 | 0.9585 | 1.0003 |
| NiK | 0.26 | 0.16 | 0.0025 | 0.9745 | 0.9683 | 1.0000 |
| Total | 100.00 | 100.00 | | | | |

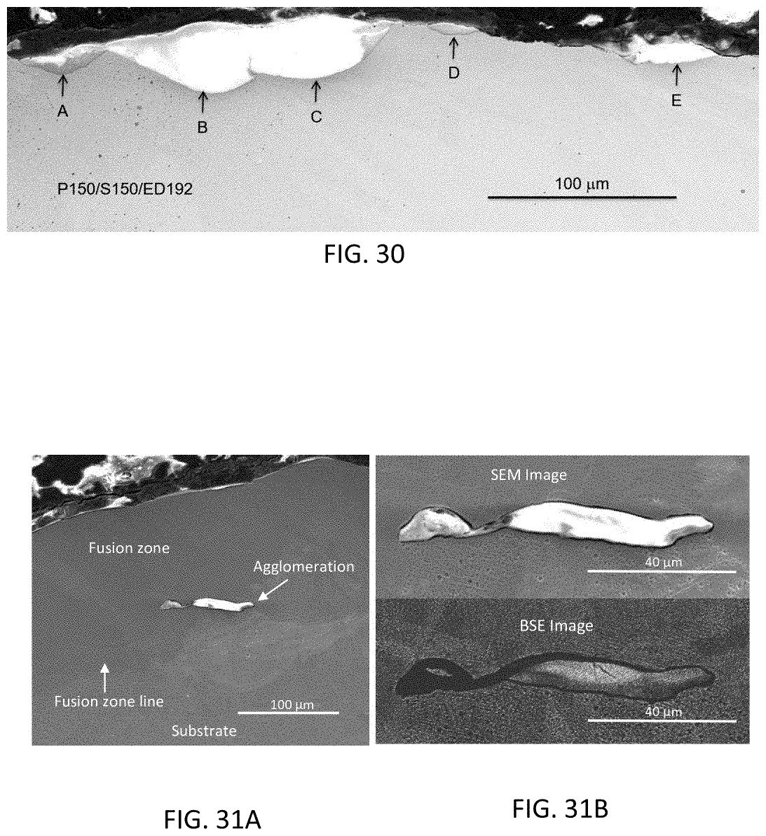

The inhomogenous distribution of surface oxides are largely explained by the deposition and preheating of the precursor film in which large amounts of ink was unused. During preheating of the samples to remove solvent prior to laser cladding, the deposited ink formed into large agglomerates largely due to the inhomogeneous deposition of ink on the substrate. To investigate this hypothesis, a second set of three samples were produced by depositing an additive precursor-containing solution in a stainless steel powder bed layer prior to laser cladding. This was done to take advantage of the wicking behavior of the ink in the powder bed, permitting a more uniform distribution of the ink across the apparent surface. After laser cladding, large agglomerates were not observed on the surface of the laser-clad powder-bed samples. EDS results for cross-sections of the three samples are shown in Table 4. An image of the cross-section is provided by FIG. 30.

TABLE 4
EDS elemental analysis of four to six location on
three different samples (P50/S150/ED64, P100/S150/ED128
and P150/S150/ED192) produced by laser cladding
powder beds infiltrated with precursor ink.

| | | A | B | C | D | E | F | Avg. |
|---|---|---|---|---|---|---|---|---|
| | | (wt %) | (wt %) | (wt %) | (wt %) | (wt %) | (wt %) | (wt %) |
| P50/S150/ED64 | O | 19.89 | 27.41 | 20.53 | 16.18 | 18.71 | n/a | 20.54 |
| | Y | 10.99 | 1.94 | 9.14 | 3.1 | 13.57 | n/a | 7.75 |
| P100/S150/ | O | 22.22 | 17.45 | 34.19 | 22.89 | 18.51 | 20.46 | 22.62 |
| ED128 | Y | 2.14 | 0.11 | 2.63 | 10.06 | 15.94 | 4.76 | 5.94 |
| P150/S150/ | O | 18.70 | 19.49 | 18.12 | 16.18 | n/a | n/a | 18.12 |
| ED192 | Y | 3.02 | 7.54 | 7.24 | 20.61 | n/a | n/a | 9.60 |
| P150/S150/ | O | 18.24 | 18.19 | 15.57 | 19.25 | 17.46 | n/a | 17.74 |
| ED192 | Y | 24.73 | 53.70 | 55.75 | 14.44 | 45.80 | n/a | 38.88 |

To embed the agglomerated yttria on this sample into the stainless steel matrix phase (a representative metal matrix phase), another layer of powder was spread on top of the already converted yttria and the sample was irradiated with the same energy density to clad the additional powder layer. FIGS. 31A and 31B show an agglomerate embedded within the microstructure of the resulting stainless steel matrix phase (FIG. 31B is a close-up image of FIG. 31A). This agglomerate is from the previous converted yttria since no additional yttria precursor was added. It was determined that the embedded structure was actually made up of two agglomerates: one comprises of mainly yttria and the other mainly Si—O—Mn.

In addition to the yttria and silica agglomerates, nanoparticles were observed in the metal matrix phase at high resolution (see FIG. 3A). This figure is very similar to the results shown in FIG. 3B, which was previously shown from the LPBF of 5 wt % ODS 304 stainless steel produced by ball-milling, layering and laser cladding. Both figures show many nano-scale particles between 10 and 100 nm.

### Example 9

In this example, concentrations of additive components (or precursors thereof) used to obtain desirable deposited amounts of the additive component within a powder bed (and any included alloy powders) is assessed. In some examples, the dispensed amount of the oxide depends on the weight ratio of Y₂O₃ in both the deposition solution and the alloy component. To print a 12 inch×12 inch stainless steel bed of 0.01 cm thick, no more than 5×10⁹ drops of 30 μL are needed for 0.1-20 wt % solid loading in stainless steel from the additive solution with 0.25-50 wt %. With 10-50 wt % Y₂O₃ in the ink, less than 5×10⁹ still can reach the solid loading in stainless steel of 20-50%. About two to six times of the drop amount can be used to achieve more than 20 wt % Y₂O₃ in stainless steel with a low additive solution concentration.

In some examples, a scan speed for printing a single pass to reach the different weight ratio of Y₂O₃ in a stainless steel bed by various additive solution concentrations can be determined. In one example, a scan speed of 1.395 inch/min with 50 wt % yttria solution provided 50 wt % solid loading in the stainless steel bed. To obtain 0.5 wt % solid loading in stainless steel from a 10 wt % yttria solution, a faster scan speed can be applied (e.g., 27.95 inch/min). When the additive solution concentration is decreased to 2 wt %, a scan speed 5.591 inch/min and 0.06inch/min can be used to obtain 0.5 wt % and 50 wt % solid loading in stainless steel, respectively. In some examples, for a 12 inch×12 inch stainless steel bed of 0.01 cm thick, only fourteen grams of Y₂O₃ are needed to provide a 50 wt % doping in the stainless steel bed.

In view of the many possible embodiments to which the principles of the present disclosure may be applied, it should be recognized that the illustrated embodiments are only examples and should not be taken as limiting the scope of the present disclosure. Rather, the scope is defined by the following claims. We therefore claim as our invention all that comes within the scope and spirit of these claims.

We claim:

1. An alloy comprising:
a metal matrix phase comprising equiaxed grains of a substantially uniform grain size and wherein the metal matrix phase is substantially free of columnar grains; and
an additive phase comprising substantially spherical nanoscale particles and wherein a majority of the substantially spherical nanoscale particles are substantially uniformly distributed within the metal matrix phase and not at external boundaries of the metal matrix phase.

2. The alloy of claim 1, wherein the additive phase is present between 0.01 wt % and 2 wt % and the metal matrix phase makes up a balance wt % of the alloy.

3. The alloy of claim 1, wherein the metal matrix phase comprises a steel.

4. The alloy of claim 3, wherein the steel comprises Fe, 18 wt % Cr, 8 wt % Ni, 2 wt % Mn, and 1 wt % Si.

5. The alloy of claim 1, wherein the substantially spherical nanoscale particles of the additive phase comprise yttrium oxide.

6. The alloy of claim 1, wherein the alloy, having been exposed to heat, exhibits a mechanical property profile providing (i) a yield strength of 280 MPa to 295 MPa after heating at 600° C.; or (ii) a tensile strength of 360 MPa to 380 MPa after heating at 600° C.

7. An alloy comprising:
a first region comprising a first metal matrix phase present in a first matrix concentration and an additive phase present in a first additive concentration, wherein the additive phase comprises substantially spherical nanoscale particles that are substantially uniformly distributed within the metal matrix phase; and
a second region having a second metal matrix phase present in a second matrix concentration that is different from the first matrix concentration; wherein each of the first metal matrix phase and the second metal matrix phase independently comprises equiaxed grains and each of the first metal matrix phase and the second metal matrix phase independently are substantially free of columnar grains.

8. The alloy of claim 7, further comprising a second additive phase present in the second region, wherein the second additive phase has a second additive concentration that is different from the first additive concentration.

9. The alloy of claim 8, wherein the second additive phase of the second region comprises substantially spherical nanoscale particles that are substantially uniformly distributed within the second metal matrix phase of the second region.

10. The alloy of claim 8, wherein a portion of the substantially spherical nanoscale particles of the additive phase are disposed in micron-scale particles within the metal matrix phase of the first region and wherein the metal matrix phase comprises Fe, 18 wt % Cr, 8 wt % Ni, 2 wt % Mn, and 1 wt % Si and the additive is yttrium oxide.

11. The alloy of claim 7, further comprising one or more additional regions, wherein each additional region comprises a metal matrix phase and an additive phase comprising substantially spherical nanoscale particles that are substantially uniformly distributed in each metal matrix phase of the one or more additional regions and wherein the additive phase of the one or more additional regions has a concentration that is different from that of the first additive concentration, the second additive concentration, or both the first additive concentration and the second additive concentration.

12. A method, comprising:
adding one or more feedstock powders comprising a metal alloy or a metal alloy mixed with an additive component to a laser powder bed;
selectively depositing one or more additive-containing solutions, one or more additive precursor-containing solutions, or a combination thereof in the laser powder bed; and
cladding a mixture provided by (i) the one or more feedstock powders and (ii) the one or more additive-containing solutions, the one or more additive precursor-containing solutions, or the combination thereof using a laser operated at a power sufficient to sinter or melt the mixture.

13. The method of claim 12, wherein the one or more feedstock powders are added to the laser powder bed before depositing the one or more additive-containing solutions or the one or more additive precursor-containing solutions in the laser powder bed.

14. The method of claim 12, wherein the one or more feedstock powders are added to the laser powder bed after depositing the one or more additive-containing solutions or the one or more additive precursor-containing solutions in the laser powder bed.

15. The method of claim 12, wherein selectively depositing comprises adding the one or more additive-containing solutions or the one or more additive precursor-containing solutions in the laser powder bed at a pre-determined region of the laser powder bed or adding a pre-determined concentration of the one or more additive-containing solutions or the one or more additive precursor-containing solutions to the laser powder bed.

16. The method of claim 12, wherein a computer program is used to selectively deposit the one or more additive-containing solutions or the one or more additive precursor-containing solutions in the laser powder bed in particular locations and/or at particular concentrations pre-determined by the computer program.

17. The method of claim 12, wherein a plurality of selective deposition steps are performed with different concentrations of the one or more additive-containing solutions or the one or more additive precursor-containing solutions so as to provide an additive-containing alloy product having regions of that have different concentrations of an additive component provided by the one or more additive-containing solutions or the one or more additive precursor-containing solutions.

18. The method of claim 17, wherein the method further comprises sintering an additive component provided by the one or more additive-containing solutions or the one or more additive precursor-containing solutions after selectively depositing the one or more additive-containing solutions or the one or more additive precursor-containing solutions, wherein sintering comprises heating using a laser operated at a power lower than a power used in cladding the mixture.

19. The method of claim 12, wherein cladding promotes rearrangement and/or dispersion of an additive component of the one or more additive-containing solutions or the one or more additive precursor-containing solutions into a metal matrix formed by cladding the metal alloy in the laser powder bed.

20. The method of claim 12, wherein the method comprises selectively depositing an additive precursor-containing solution comprising Y(NO3)3, urea, and an alcohol; and wherein the feedstock comprising the metal alloy is a stainless steel feedstock powder and wherein cladding the mixture provided by the feedstock and the additive precursor-containing solution comprises exposing the stainless steel feedstock powder and the additive precursor-containing solution to a laser operated at a power ranging from 100 W to 150 W.

21. The method of claim 12, wherein the method further comprises sintering an additive component provided by the one or more additive-containing solutions or the one or more additive precursor-containing solutions after selectively depositing the one or more additive-containing solutions or the one or more additive precursor-containing solutions, wherein sintering comprises heating using a laser operated at a power lower than a power used in cladding the mixture.
